(19) United States
(12) Patent Application Publication
(10) Pub. No.: US 2007/0288249 A1
(43) Pub. Date: Dec. 13, 2007

(54) Integrated Animal Management System And Method

(76) Inventors: James Baber Rowe, New South Wales (AU); Kevin David Atkin, New Soth Wales (AU); Stephen James Semple, New Soth Wales (AU); Jessica Susan Richards, New South Wales (AU); William Keith Murray, New South Wales (AU); Andrew David Fisher, New South Wales (AU); David John Miron, Armidale New, (AU); John Patrick Exley, Loganlea Queensland (AU); Ian Gordon Colditz, New South Wales (AU); Matthew John Kelly, Ontario (CA); Malcolm Knox, New South Wales (AU); Brown Besier, Western Australia (AU)

Correspondence Address: MEDLEN & CARROLL, LLP, 101 HOWARD STREET, SUITE 350, SAN FRANCISCO, CA, 94105, US

(21) Appl. No.: 11/578,392

(22) PCT Filed: Mar. 18, 2005
(86) PCT No.: PCT/AU05/00393

§ 371 Date: Aug. 2, 2007

(30) Foreign Application Priority Data
Apr. 13, 2004 (AU) 2004901941
Sep. 24, 2004 (AU) 2004905559

(51) Int. Cl. G06F 19/00; A01K 29/00

(52) U.S. Cl. 705/1; 119/511; 340/573.1

(57) ABSTRACT

The present invention relates to a system for the intensive management of animals, the system comprising: animal identification means for identifying individual animals; at least one device for measuring one or more parameters of individual animals; a processor for processing measurements obtained for the one or more parameters, wherein the processed parameter data is used to determine management strategies for individual animals in real-time; and means for implementing management strategies for the animals.

### TECHNICAL FIELD

The present invention relates to an integrated animal management system for monitoring and assessing the health and condition of animals, in particular grazing animals, from a remote location and implementing management decisions on the basis of the assessments made.

### BACKGROUND OF THE INVENTION

Management of livestock, in particular grazing animals, for health, welfare and productivity requires regular measurement and monitoring to ensure the absence or control of disease and parasites, adequate intake of food and water and the general wellbeing of the animals. Current methods and systems for the monitoring, measurement and analysis of grazing animals is labour intensive and time-consuming often requiring the presence of multiple individuals including for example a farmer/grazier, veterinarian and technician, to physically take measurements and samples from the animals for analysis.

Measurement and monitoring can be in the form of visual inspection to see if all animals appear well and that there is sufficient food and water for all animals. It is also possible to measure parameters such as change in body weight, core body temperature, outward signs of anaemia or discolouration of skin and/or membranes, indicating metabolic disorders. Samples of faeces or body fluids such as blood, urine or saliva can also be taken for analysis of chemical or biological agents indicative of disease or abnormal metabolism.

Typically, to facilitate measuring and sampling, animals are herded into yards or sheds where they can be caught in confined areas or channelled through a race where they move single file to be restrained for sampling. Measuring, sampling and monitoring can be enhanced if animals carry some form of identification such as an ear tag that allows a measurement or observation to be linked to an individual animal. However management of groups of animals is still labour-intensive and time-consuming. In view of the manual nature of animal management, there is often a significant lag time between making measurements and taking samples from animals in the first instance and subsequently implementing a management strategy for the animals based on the results of the measurement, sampling and analysis. Typically, animals may be grazing over large areas, requiring them to be herded for the purposes of manual analysis. The animals are then released to continue grazing while results of the analyses are obtained and a management strategy devised. The animals must then be herded a second time in order to implement the management strategy. Further the time and cost of management makes frequent monitoring impractical and reduces the ability to attend to the needs of individual animals and manage individual animals on the basis of their specific needs.

The development of a systematic approach to the monitoring and management of grazing animals such as sheep has been hampered by the peculiarities of these animals and of raising such animals, in particular, the variety of production environments (grazing and confined feeding) and the range of disease and parasite conditions unique to grazing animals. For example, sheep are subject to a number of unique diseases and conditions such as specific parasitic infections. Additionally, the effect of wool in insulating and altering the external appearance of grazing animals such as sheep must also be taken into consideration.

Accordingly there is a need for new systems and methods for collecting measurement data from grazing animals such as sheep and for utilising and integrating the data obtained for implementing appropriate and effective management decisions in real-time that will maintain health, welfare and productivity of the animals.

### SUMMARY OF THE INVENTION

According to a first aspect of the present invention there is provided a system for the intensive management of animals, the system comprising:
(a) animal identification means for identifying individual animals;
(b) at least one device for measuring one or more parameters of individual animals;
(c) a processor for processing measurements obtained for the one or more parameters, wherein the processed parameter data is used to determine management strategies for individual animals in real-time; and
(d) means for implementing management strategies for the animals.

The animals may be grazing animals, for example, sheep, cattle, goats or horses.

The one or more parameters may include weight, temperature, odour, gas, colour and visual characteristics.

The system may further comprise a database for storing processed parameter data. The database may additionally store historical data for individual animals. The historical data may include one or more of the following: genetic data; pedigree information; phenotypic characteristics; and previous parameter data processed by the processor. The previous parameter data may have been used in determining previous management strategies for individual animals.

The processor may correlate real-time processed parameter data with historical data stored in the database and/or external information to determine the management strategy for an individual animal. The external information may include one or more of market information, transactional information, environmental information and industry benchmarks for animal health and performance.

The processed parameter data and/or historical data for an individual animal may be compared with corresponding processed parameter data and/or historical data for one or more other animals in the same group to determine the management strategy.

The management strategy determined may be implemented for more than one animal within the same group.

In a particular embodiment, the animal identification means comprises a tracking device, the tracking device comprising a transponder attached to the animal and a receiver. The receiver may be located in a race, gate or adjacent a feed or water trough. Alternatively satellite receivers may be employed. The at least one device for measuring one or more parameters (b) may also be located in the race, gate or adjacent the feed or water trough. In one embodiment the gate is a spear gate, boom lever, animal-activated gate, electronically activated gate or other suitable gating mechanism.

In a particular embodiment the at least one device for measuring one or more parameters is selected from the group consisting of: a weighing device; a load sensor, a temperature detector; an electronic eye; an odour detector; a gas detector and an image analysis device. The processor may include an algorithm to calibrate parameters of weight, temperature, odour, gas emissions, colour or other characteristics of an individual animal with disease, nutrition and performance states to diagnose the state of health and performance of the animal and determine the management strategy for the animal.

The weighing device may comprise a platform suspended between two or more load cells and the processor may include an algorithm to calibrate weight and weight change in an animal with nutritional state, disease conditions, parasitic infections and nutritional value of pasture and feed. The parasitic infections may be infections caused by external parasites, including blowflies and lice, or internal parasites, including Trichostrongylus colubriformis, Trichostrongylus vitrinus, Ostertagia circumcincta, Haemonchus contortus and Nematodirus spp.

The load sensor may sense the speed and weight placement of an animal's feet on the sensor thereby indicating temperament and/or physical impairment of the animal.

Electronic eyes and detectors may be used to count animals and/or measure their speed of movement.

The temperature detector may be an infra-red thermal scanner for detecting the body temperature of an animal and the processor may include an algorithm to calibrate temperature and temperature changes in the animal with disease conditions, parasitic infections or heat stress.

The odour detector may be an electronic sensor to detect the odour emitted from one or more locations on an animal and the processor may include an algorithm to calibrate the odour emitted with conditions including flystrike, footrot, fleece rot, dags, diarrhoea, acidosis and internal or external parasitic infections. The odour detector may further comprise air sampling means for sampling air surrounding regions of an animal's body, the sampled air being used in the diagnosis of conditions including flystrike, footrot, fleece rot, dags, diarrhoea, acidosis and internal or external parasitic infections.

The gas detector may sample gas emitted from the mouth, nose and/or anus of the animal to detect metabolites, and the processor may include an algorithm to calibrate metabolite levels with weight loss, fermentative ability of the animal and nutritional requirements of the animal. The metabolites may include methane and ketone bodies.

The gas detector may sample gas and volatile compounds emitted from a faecal sample collected from the terminal colon or freshly deposited on the ground, and the processor may include an algorithm to calibrate presence of certain volatiles with weight loss, fermentative ability of the animal and nutritional conditions to determine the presence of specific parasites, diarrhoea or metabolic disorders.

Dogs may be trained to detect odours emitted from one or more locations on an animal and the response of the dog to the specific odour through either audio (barking) or physical (pushing on a lever, plate or button) action can be entered to a processor to identify animals with disease conditions including flystrike, footrot, diarrhoea, acidosis, metabolic disorders and internal parasitic infections. This form of odour detector may further comprise air sampling means for sampling air surrounding regions of an animal's body, the sampled air being blown past the area where the dog is located adjacent to the sheep race. Trained dogs may also be used to detect specific odours emitted from a faecal sample collected from the terminal colon or freshly deposited on the ground.

Dogs are trained to recognise specific odours associated with disease conditions including flystrike, footrot, diarrhoea, acidosis, metabolic disorders and internal parasitic infections using samples from animals with known status with respect to flystrike, footrot, diarrhoea, acidosis, metabolic disorders and internal parasitic infections using positive reinforcement conditioning based on feed and ‘click’ rewards.

The image analysis device may be a scanning device or digital camera, such as a still or video camera, to detect pigment and colour of an animal's skin, and wherein the processor includes an algorithm to calibrate colour and pigmentation with red blood cell levels, metabolic disorders and disease conditions. The metabolic disorder may be haemonchosis resulting in anaemia.

The image analysis device may be a scanning device or digital camera to detect pigment and colour of an animal's skin, and wherein the processor includes an algorithm to calibrate colour and pigmentation with the presence of faecal and urine stains (‘dags’), flystrike, pizzle rot, or other form of damage to wool or skin including injury from predators. Detection of pigmentation can be used in conjunction with algorithms to incorporate information on weight, weight loss, weather condition, and odour to provide a more accurate diagnosis.

In a particular embodiment the processor correlates data for any two or more measured parameters to determine the management strategy for an individual animal or group of animals.

In a particular embodiment the management strategy comprises determining and/or implementing an effective treatment for the animal, including feed requirements, chemical treatment requirements, quarantine requirements or other welfare requirements of the animal as well as grouping animals for sale or genetic selection. Feed requirements may include formulations of protein and/or amino acids or other feed supplements, medicated and feed and water intake levels. Chemical treatment requirements may include antibiotics, anti-fungal agents and antiparasitic agents active against internal or external parasites.

In a particular embodiment the means for implementing management strategies comprises means to draft one or more animals into a predetermined location thereby enabling the appropriate treatment as defined above to be administered to the one or more animals. The means for implementing management strategies may further comprise automatic means for administering the required treatment.

In a particular embodiment of the system the processor (c) is remote from the animal identification means (a) and at least one device (b), and wherein the system further comprises:

(f) a transmitter for transmitting measured parameter data from the at least one device (b) to the processor (c).

The data may be transmitted via digital wireless network or satellite modem for remote Internet-based access.

According to a second aspect of the present invention there is provided a system for the intensive management of sheep, the system comprising:
(a) identification means for identifying individual sheep;
(b) at least one device for measuring one or more parameters of individual sheep;
(c) a processor for processing measurements obtained for the one or more parameters, wherein the processed parameter data is used to determine management strategies for individual sheep in real-time; and
(d) means for implementing management strategies for the sheep.

According to a third aspect of the present invention there is provided a method for the intensive management of animals, the method comprising the steps of:
(a) identifying individual animals;
(b) measuring one or more parameters of identified individual animals;
(c) transmitting the measured parameter data to a central processor;
(d) processing the transmitted data; and
(e) determining and/or implementing management strategies for individual animals on the basis of the processed data in real-time.

### BRIEF DESCRIPTION OF THE DRAWINGS

Particular embodiments of the present invention will now be described, by way of example only, with reference to the accompanying drawings:

FIG. 1. Schematic illustration summarising the components of an integrated animal management system according to an embodiment of the present invention illustrating the integrated flow of information through collection, decision support and implementation processes.

FIG. 2. Illustrations of walk-through weighing units for use in an integrated animal management system according to an embodiment of the invention. A. A one-way walk through weighing unit: (i) flow control using spear gates at entry and exit and including an animal flow module; (ii) flow control using exit only spear gates. B. A bi-directional walk through weighing unit. C. A battery of walk through weighing units allowing large throughput of animals.

FIG. 3. Antenna configurations for RFID track and trace systems according to an embodiment of the present invention. A. Fence line configuration parallel to flow of livestock. B. Portal configuration across flow of livestock. C. On-ground configuration of walk over antenna. D. Portal orientation across a gateway. E. On-ground orientation in a gateway. F. Portal orientation at edge of feed or water trough. G. On-ground orientation in front of feed or water trough. H. Panel orientation located on gates.

FIG. 4. Time course of weight change and expected weight for an individual sheep. A. New weight within expected bounds as determined by an algorithm according to an embodiment of the present invention. B. New weight outside expected bounds as determined by an algorithm according to an embodiment of the present invention.

FIG. 5. A flow diagram depicting the flow of animals and data when an animal enters a walk through weighing unit that supports drafting.

FIG. 6. Liveweight change (A) and feed intake (B) over time (days) for sheep with no infection (Contr), sheep infected with blowfly larvae (Struck) and pair-fed controls (PFC).

FIG. 7. Electronic odour detection traces over time from samples of clean wool (A), pads from skin of blowfly infected sheep (B), matted wool containing faeces and urine (C) and bacterial cultures from sheep affected by fleece rot (D).

FIG. 8. Average daily weight gain over a 9 week period for sheep infected with Haemonchus contortus as compared with uninfected sheep.

FIG. 9. Electronic odour detection traces over time from samples cobatining faecal material obtained from sheep with no internal parasites (A), Ostertagia circumcincta (B) or Haemonchus contortus (C).

FIG. 10. A walk-through weighing unit designed for supplementary feeding of animals in feed paddocks (A-E).

FIG. 11. Exemplary data entry screen capture from Virtual Raceside Classer software.

FIG. 12. Exemplary screen capture from Virtual WoolClasser software.

### DETAILED DESCRIPTION

The present invention relates to an Integrated Animal Management System (IAMS) able to integrate information and data obtained at point of measurement with information on the identity of an animal, past measurements, current market information and transactional information in order to make and implement sophisticated management decisions in real-time based on the requirement and potential of each individual animal. The IAMS of the invention also provides for individual management of animals through differential nutrition, medication, breeding, easier handling and precision marketing. By managing individual animals there is also provision for the exclusion of feral animals from facilities designed for the purpose of domesticated livestock.

Accordingly, the present invention provides a system for the intensive, integrated management of animals, the system comprising: identification means for identifying individual animals; at least one device for measuring one or more parameters of individual animals in real-time; a processor for processing measurements obtained for the one or more parameters, wherein the processed parameter data is used to determine management strategies for individual animals in real-time; and means for implementing appropriate management strategies for the animals.

As used herein, the term “real-time” when used in relation to the determination of management strategies, means that the parameter data obtained is used in the decision making process for determining a management strategy within a short and predictable time frame. In particular, “real-time” means that management strategies are determined substantially immediately after parameter measurements have been made and parameter data processed for any particular animal, without significant lag time and without the animals being released for grazing and needing to be herded back into yards to implement requisite management procedures.

In a particular embodiment, a system of the present invention provides a combination of measuring and detection equipment integrated with computer software and associated algorithms that allow monitoring of animals for early detection of disease/parasites to maintain health and welfare as well as management of the animals to meet production targets. By combining real-time measurements with previously obtained data, external data, information and benchmarks, together with the ability to draft animals according to the their individual requirements and potential, the value of an IAMS of the invention may be particularly realised.

The measuring and detection equipment may be calibrated specifically for measurement and detection of individual species of animal, and the computer software and algorithms designed so as to enable measurements collected for animals of that species to be correlated for the assessment and diagnosis of conditions and diseases particular to that species. This allows the system to be tailored to the specific requirements of management of a particular species.

The present invention is particularly applicable to the management of grazing animals, for example sheep. As used herein the term “grazing animals” refers to those animals typically managed using extensive management practices. Embodiments of the invention are described below in terms of the applicability of the invention to sheep, however those skilled in the art will readily appreciate that the invention as described may also be implemented for the management of other animals, in particular other grazing animals including but not limited to goats, cattle and horses grazing under extensive conditions. The present invention also finds application in the monitoring and management of wild species.

Integrated Animal Management System

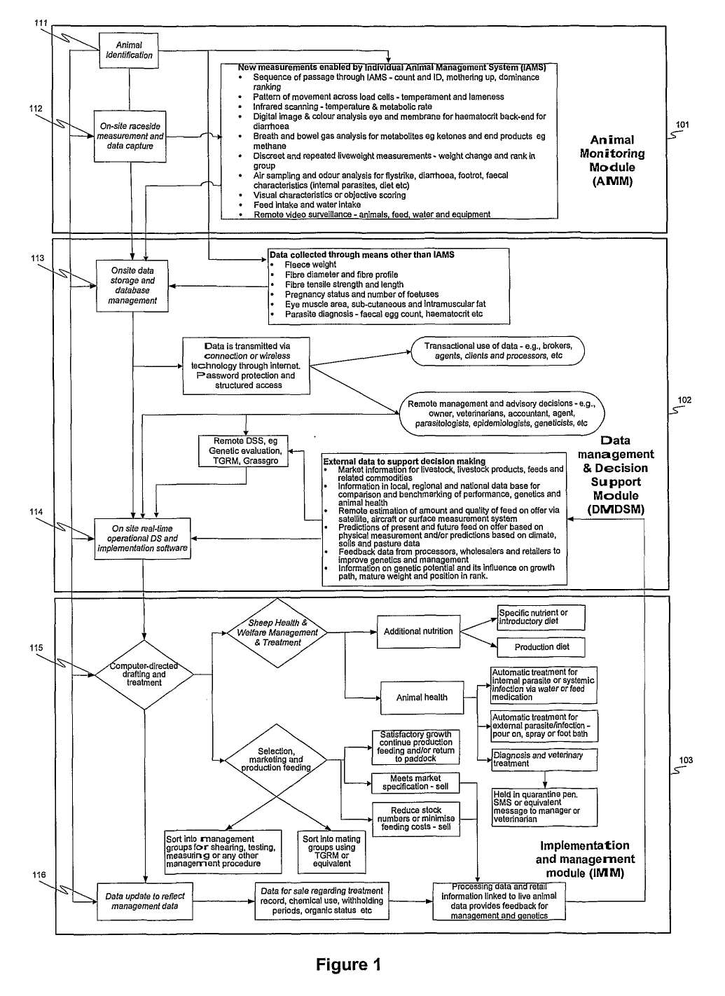

An Integrated Animal Management System (IAMS) according to an embodiment of the invention is summarised in FIG. 1. According to this embodiment, the IAMS comprises three core or “backbone” modules, defined herein as the Animal Monitoring Module 101, the Data Management and Decision Support Module 102, and the Implementation and Management Module 103. As illustrated in the system of FIG. 1, the IAMS can be further divided into six sub-components—Animal Identification 111, On-Site Raceside Measurement and Data Capture 112, On-site Data Storage and Database Management 113, On-Site Real Time Operational Decision Support and Implementation Software 114, Computer-directed Drafting and Treatment 115 and Data Update 116. These components communicate with each other as well as being capable of communicating with various sources of external information and decision support inputs.

The Animal Monitoring Module 101, Data Management and Decision Support Module 102 and Implementation and Management Module 103 of the LAMS may be separate facilities or located in one or two combined facilities. That is, the Animal Monitoring Module is required to be physically proximal to the animal or group of animals to be managed, whereas either or both of the Data Management and Decision Support Module and Implementation and Management Module may be remotely located with respect to the animal or group of animals to be managed.

The discussion below relates to measurements made electronically and/or to the electronic inter-connection of various components. However, those skilled in the art will readily appreciate that it is also possible to enter certain information manually in order to exploit the functionality of the IAMS of the present invention. Similarly the IAMS includes integrated modules for automatic drafting and treatment of animals that can be equally performed manually based on information derived from the integrated data management and decision support components.

1. Animal Monitoring Module (AMM)

The AMM module 101 comprises equipment arid functionality to identify individual sheep, measuring systems and devices to measure parameters of individual sheep and animal control and training systems that ensure animals pass through the AMM in single file separated by sufficient distance to ensure identifiable and discreet measurements are correctly attributed to each animal. The equipment in the AMM may comprise an animal identification detector/counter, the combination of identification detector and weighing platform suspended on load cells and any additional measurement equipment as described below. The AMM is typically integrated with a drafting/sorting device either operated manually or computer directed.

The AMM of the system according to the invention is typically designed for a one-way flow of animals and ‘spear’ trap gates may be used at the entry and/or exit points to ensure unidirectional passage of animals through the module. Sheep, particularly Merino sheep, have a strong Leader-Follower behavioural structure, and also tend to display a high degree of synchronization of behaviour. Thus sheep tend to move as a group towards water, usually in the morning or late afternoon, and usually strung out behind a lead animal. Therefore, the sheep readily follow one another through the AMM Module once trained to do so. Animal flow control and separation is maintained to facilitate data collection and drafting. A number of mechanisms may be used to control the flow of the sheep through the entry point. Examples of some of these mechanisms are hock bars, ramps and automated gates operating either through mechanical means driven by electric motors, compressed air or by mechanical forces related to the animal's transfer of weight or movement as it passes trough the unit. Other mechanisms also suitable for controlling the flow of animals will be known to those skilled in the art.

Animals are preferably trained to pass through the AMM by early life experience with or without the presence of their mother. Sheep learn about home range geography and foraging strategies from their dam, so employing the AMM in a paddock with ewes and their lambs optimises early training. Training commencing later in life is a staged process, preferably with progressive construction of the AMM around an access point to water or supplementary feed, or a molasses-containing mineral lick block or night camp. Training can be achieved by using feed, water or other attractant as a reward. The AMM may also be located in a gate way between paddocks so that animals may be monitored as they pass between paddocks during rotational grazing routines. Animals typically pass through gating mechanisms more freely, with less nervousness, if the surface and surrounds are familiar. Aids to achieving a good surface and environment include the use of solid material or shade cloth along the sides of the race and the use of surfaces such as concrete tiles or slab, artificial grass, gravel etc on the platform.

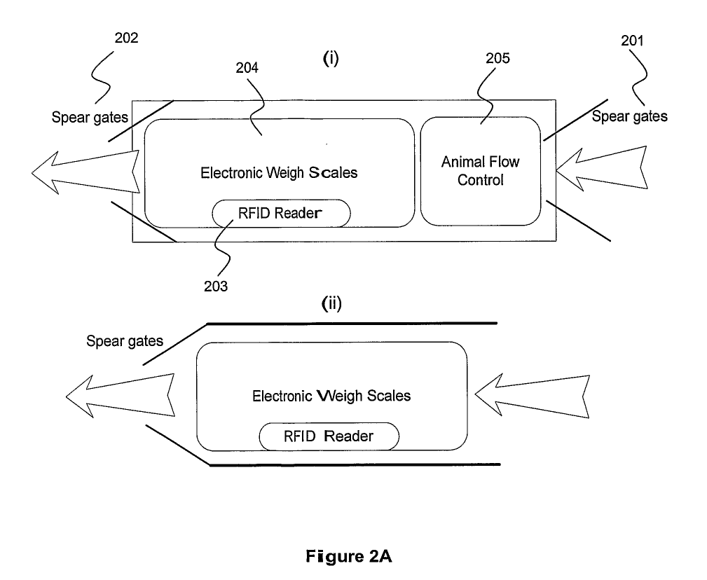

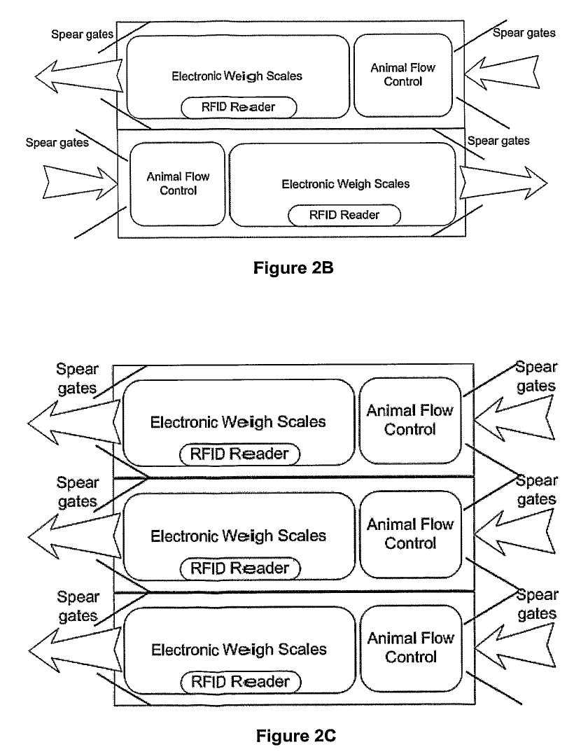

There are various possible configurations of the flow-control and monitoring aspects of the system according to the invention. For example, a system maybe a simple one way system as shown in FIG. 2A. The system illustrated in FIG. 2A(i) comprises a race with spear gates upon entry 201 and exit 202. The race also includes a radio frequency identification reader (RFID) device 203 (described below) linked to electronic weigh scales 204. The weigh scales may be, for example, a platform suspended between two or more load cells (described in more detail below). After passing through the spear gate 201, flow of the animals is controlled 205 to ensure animals pass the RFID reader 203 and cross the weigh scales 204. An alternative configuration is illustrated in FIG. 2A(ii) in which flow control is only achieved using spear gates 202 at exit. A further alternative embodiment of the system of FIG. 2A(i) is shown in FIG. 2B where the animals are identified and weighed in two directions. For high volumes of animals, a parallel system such as that shown in FIG. 2C may be implemented.

(a) Animal Identification (111)

The first component of an IAMS of the present invention comprises means for identifying individual animals for the purpose of recording measurements, retrieving archival data, for drafting and the implementation of management strategies. In one form identification of animals is based on radio frequency (RF) transponders, or equivalent, incorporated into an eartag, leg tag, collar or bolus embedded within the animal, for example in the rumen or sub-cutaneously. The transponder is activated when an animal walks past a transceiver, or equivalent detection device. Transceivers are typically placed in a race leading to, or from, water or feed or between two paddocks when animals are moving from one to the other. Alternatively, transceivers can be located at any point where animals move past voluntarily or as part of a management activity, for example as animals move through sale yards or as animals are loaded onto, or unloaded from, vehicles for transport. RF identification tags may be either passive or active, low or high frequency, dual frequency, Full Duplex (FDX) or Half Duplex (HDX) read only or combinations of read/write and may have anti-collision properties enabling multiple tags to be read simultaneously in a single read zone. The RF identification readers/writers may be stick or panel devices, communicating with a data logger using wires, Bluetooth, WLAN or other wireless technology.

Dual Frequency RFID

In one embodiment a dual frequency (125 kHz/7 MHz) RFID system may be employed. Such dual frequency systems typically comprise two components—a loop of wire as the transmission cable, such as a heavy-duty, low resistance speaker wire and a loop of, for example, coaxial or double-strand electrical wire. These two cables can be run together in a single piece of PVC conduit or preferably poly-pipe resistant to animal hoof damage.

The system may be employed for in-race identification of animals. For in-race applications, a “panel’ type RFID configuration may be adopted involving, for example, a wire loop for the transmission and another for the read. The read may be further improved by having a transmission loop on either side of the race. Alternatively the configuration may be in the form of a “portal”, in which one loop of the transmission and reader cables form a hoop around the race, providing a 3-dimensional read as animals move through the race. An alternative design could include a loop with a plug (break) in order to thread the loop through a fixed race.

For walk-through systems, aerials can be constructed in the form of mats (for example similar to those used for marathon and mass participation athletic events) or a portal through which animals walk. The portal typically requires a complete loop around a gateway entrance. Mat systems include the transmission aerial in a loop on the ground extending across the gate or lane way and a slightly more complex configuration of loops and cross-overs for the reader cable. The transmission wire is typically low resistance and speaker cable is one appropriate choice for this purpose. Typically the reader loop is coaxial cable, although twin strand electrical wire can be used. For portal readers, a PVC or poly-pipe loop can be run along the ground, up the gate posts and then tensioned across the top of the gate at a height allowing sheep to move under the top of the loop.

Multiple reader antennae units can be located at different locations on the farm or on trucks, sale-yard race ways, for example, without requiring a ‘black box’ reader at each location. The ‘black box’ reader can be moved to the various antennae as and when needed.

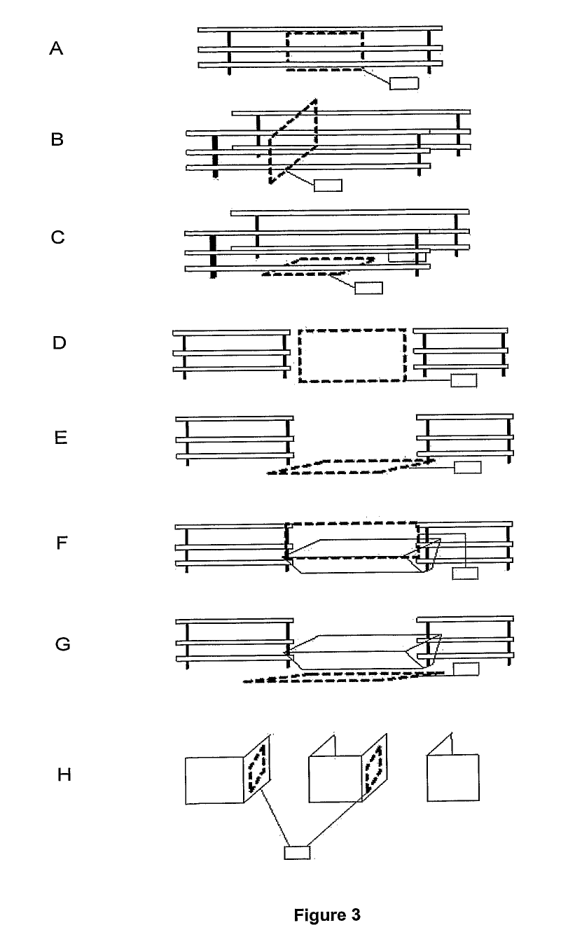

RFID including dual-frequency tags and readers offer a solution for a variety of aspects of sheep management and traceability. By way of example, some of the applications of such a system are illustrated in FIG. 3.

As shown in FIG. 3A, 3B and 3C, fence-line, portal and on-ground antennae configurations respectively may be used for in-race applications during weighing of animals and during other management activities. The anti-collision characteristics and gateway use of the readers in such systems enable the identification of patterns of animal movement and close association between individuals such as ewe and lamb. Further NLIS (track and trace) applications such as identifying sheep going onto trucks, leaving trucks, entering sale-yards or abattoirs, are possible with simple portal or mat readers and the anti-collision properties of the tags. In FIG. 3A, the antennae are placed parallel to the flow of animals. Antennae can be placed on both sides of the race. One antenna may be bent half over the race and one bent half under under the race. Typically the receiver antenna is placed on one side of the race only. FIG. 3B illustrates a portal configuration across the flow of animals, whereas FIG. 3C illustrates an on-ground configuration of a walk over antenna. As with the configuration of FIG. 3A, one antenna may be bent half over the race and one bent half under under the race, and typically the receiver antenna is placed on one side of the race.

Portal or on-ground orientations (FIGS. 3D and 3E) may be used for through-gate identification and counting of animals as they are moved from paddock to paddock or as they leave the yards after any treatment or checking following separation into management/mating groups.

Antenna configurations may also be adapted for use in intensive feeding systems, for example to identify shy feeders or select for animals with particular feeding behaviour (see FIGS. 3F and 3G). For example, antennae can be run as a loop through which animals put their head as they eat (or drink) and separate antennae up to 5-10 metres of trough space should be possible. Multiple troughs can be monitored with multiple hoops.

As illustrated in FIG. 3H, antenna configurations can also be adapted for applications such as in shearing sheds. A single reader can service multiple antennae located at shearing pen gates and therefore monitor which sheep are shorn by which shearers as well as identifying the fleeces following shearing. Tags may accompany the fleece. It is also simple to have an additional antenna at the point of fleece-weighing.

Alternatives to RF identification include other electronic devices, a combined visual-electronic device (such as bar codes) and visual tags with alpha-numeric information for fully visual recording. Chips for global positioning may also be incorporated with the electronic identification devices.

In addition to enabling the identification of individual animals, the identification means is able to record the sequence with which specific animals move past the identification reader. The order in which animals pass a given location is of significance in determining, for example, behavioural characteristics and genetic links such as between mother and offspring.

(b) On-Site Raceside Measurement and Data Capture (112)

As animals pass through the Animal Monitoring Module 101 and are identified, measurements can be made for monitoring and managing animals on an individual basis. Determination of appropriate treatment and management strategies can be made in real-time on the basis of real-time parameter data gathered, or on the basis of prior information stored for a particular animal (historical data) or on the basis of a combination of both real-time parameter data and historical data.

The IAMS of the invention enables a range of new measurements and novel interpretations of existing measurements.

Counting and Order with Which Animals Pass Through the AMM

Counting individual animals as they move between one paddock to another or as they move to and from water or feed, and recording the order of passage can provide valuable information. Initially, counting animals may be used to determine that all animals are present and sufficiently healthy to walk past the detection apparatus.

Additionally, the order in which individual animals pass through the AMM may be recorded and analysed to yield sources of information. Sheep typically display a ‘follower’ relationship with their mother, thus dams and their offspring tend to move together particularly when visiting water or feeding. The order in which the RFID tags associated with offspring are read relative to tags associated with dams is recorded and analysed over repeat observations to determine the probability that a particular offspring is associated with a dam. The analysis depends on an algorithm developed through measurement of animals with a known pedigree relationship between dams and their offspring when these animals are allowed to pass through the AMM under normal management conditions. The algorithm may initially be determined by monitoring, for example, 30 ewes and lambs over a period of four weeks in order to determine the period of observation and the most appropriate age of the lambs in order to collect the data and analyse it in the most accurate way. The analysis and development of the algorithm uses standard mathematical techniques based on separation analysis.

A further use of spatial separation information relating to the order in which animals pass through the AMM involves animals of the same age in order to determine whether certain animals are visiting water and feed more slowly (less frequently) or more often than others. A change in the pattern may reflect a change in animal health or welfare relative to other animals in the same group. The algorithm for this analysis may also be developed using standard mathematical procedures based on separation analysis.

Information obtained can be corroborated with the findings with other observations and measurements. For example those animals passing through the AMM less frequently, and also losing weight, may require closer examination and a veterinary diagnosis.

Pattern of Movement

The stream of data passing from the load cells to the data logger (described in detail below) while an animal walks across the platform provides valuable information on the temperament of the animal and can also be used to indicate whether there are signs of lameness. Animals that are calm and showing no signs of stress typically have an even gait and place similar weight on each foot. Animals that are nervous tend to walk with a more rapid movement with each foot in contact with the platform for shorter periods of time. If one or more feet, or limbs, are not taking an appropriate amount of weight the animal is diagnosed as being lame and identified for attention.

‘Flight time’ recorders can be used to measure the speed of the animal as it passes through the AMM or as it leaves the AMM. The relative speed of the animal has been found to be related to its temperament. For example, cattle passing more slowly from a crush have been found to have more tender meat than similar animals that move more quickly out of the race. Information about the temperament of an animal can be used when making breeding or management decisions as this characteristic can influence future production.

Temperature Measurement

Temperature can be measured remotely by infra-red scanning of the head or body region as the animal moves through the AMM. The algorithm to determine core body temperature from the infrared scan is developed through experimentation and involves measurements on multiple sheep with different amounts of wool, varying levels and type of feed and a range of climatic conditions. Information from the temperature measure can be used in conjunction with weight change and other parameters to determine animals likely to have an infection as well as animals that may be suffering from heat stress.

Digital Image Analysis

As an animal passes through the AMM it is positioned in such a way as to allow digital image analysis of parts of its face, not covered by hair (in particular the nose and eyes) and this image can be correlated, on the basis of red pigmentation with concentrations of haemoglobin in the blood and used as an index of anaemia and the presence of bloodsucking parasites, particularly Haemonchus contortus. Further information from digital scans of the area of inside leg free from wool can be used as an alternative site to determine haematocrit. Image analysis of the tail end of the sheep can be used to determine the incidence of diarrhoea associated with acidosis, parasites or other nutritional disorders. Image analysis in a micro unit attached to the forefinger can be used to analyse membranes and blood vessels in the eye. This procedure may involve manual restraint of the animal, reading of the identification tag and examination of the opened eye with a micro digital image unit. The manual check is normally only used for confirmation of suspected cases. Digital image analysis can be used on walk through examination to determine incidence of ‘dags’ around the tail and on the back legs (drafting out dirty lambs/sheep for crutching prior to shearing or shipment to market). On its own, or combined with odour detection this information can provide differential diagnosis of scouring as a result of acidosis, lush green feed and internal parasites.

The appearance of sheep suffering from lice may change as they rub against trees and fences. This process of rubbing and scratching produces loose wool and balls of felted wool on the surface of the fleece that gives animals a distinctive appearance that can be remotely detected through video image analysis of sheep as they walk through, for example, the weighing or odour detection unit. Animals detected in this way can be drafted and treated. Such detection can be used to indicate that the whole flock should be treated for lice.

Breath and Bowel Gas Analysis

Gas produced by an animal through metabolism or fermentation can be sampled and analysed to determine the physiological status and requirements for treatment or nutrition. Gas expired through nose and mouth includes expired air from the lungs and gas from fermentation eructated via the oesophagus. Expired air contains ketone bodies when the animal is in negative energy balance and utilizing lipid reserves. The ratio of methane to carbon-dioxide and nitrogen gives an indication of the pattern of fermentation and the efficiency with which feed is used relative to the emission of greenhouse gases. Gas released as flatus reflects fermentation in the caecum and colon and reflects the extent of undigested feed fermented in the hind-gut.

Sampling of gas may be achieved by a vacuum pump activated in response to the animal RF identification tag registered with the in-race reader. The air pump may have specifications consistent with taking a sample of approximately 200 mls from an area adjacent to the nose of the sheep within a period of one to two seconds. The sample may be streamed to remove air that accumulates in the dead space of the sampling line and the sub-sample enters either a ketone analyser or a methane analyser depending on the settings and nutritional conditions being monitored. Results from the analysers are linked with the identification of the animal and enter the central data storage.

Analysis of ketone bodies may be via odour detection or using standard methods of chromatography. Methane analysis may be conducted using commercial monitoring equipment used for industrial and mining applications.

Dogs may be trained to identify sheep or samples taken from sheep or faecal material excreted from sheep that are associated with conditions including flystrike, footrot, diarrhoea, acidosis, metabolic disorders and internal parasitic infections. A dog positioned beside a race through which sheep move does not distract sheep provided that the dog is obscured from view by the sheep. The dog may be located in a kennel like enclosure adjacent to the race with air sampled from around the sheep passed close to the nostrils of the dog. For faecal samples deposited on the ground or samples taken from the terminal colon the dog sits beside the handler.

Walk Through Weighing and Analysis of Repeat Measures of Liveweight

The following sequence is typical of a walk through weighing process according a system of the invention.
As an animal moves through the AMM the RF identification reader/writer reads the electronic identification and sends the identification to a data logger where it is stored.
The animal walks across the electronic weigh scales. The electronic weigh scales stream weights back to the data logger where they are subsequently applied to a signal processing type algorithm and the weight calculated.
The animal is detected as leaving the electronic weigh scales by zero weights.
The weight is then stored against the identification of the animal.

In an embodiment of the invention electronic weigh scales have the capacity to stream weights back to the data logger for processing by the weighing algorithm within the data logger. Examples of suitable scales are those manufactured by Ruddweigh and TruTest.

The specific algorithm may be determined, for example, by calibrating the walk over weighing data stream for 25 animals of known weight each passing over a weighing platform on twenty separate occasions. Through mathematical procedures the correlation between load cell signal and actual weight is converted to an algorithm that predicts actual weight from the load cell signal. The accuracy of the algorithm is then verified by passage of another 25 animals over the load cells on ten separate occasions.

For example, in one embodiment, the weigh scales provide weights at 10 readings per second These readings provide a signal S consisting of N weights. When a sheep moves onto the scales the weights monotonically increase until the sheep is completely on the platform. At that point the weights plateau. When the sheep moves off the scale the signal monotonically decreases to zero. If the plateau of the signal is represented as P and each weight within the Plateau is represented as pᵢ then the algorithm for determining the estimated weight E becomes:

$$E = \frac{{\sum }_{i = 1}^{\vert P \vert} {p}_{i}}{\vert P \vert} \qquad ( 1 )$$

Equation 1 states that the weights of the plateau are summed and divided by the total number of weights in P, giving an average of the signal within the plateau. The plateau is identified by finding the midpoint of the signal S and then backtracking to identify the plateau end points. The plateau end points are identified when there are five consecutive decreases in weight.

In a particular embodiment of the invention the software/hardware configuration of the components of the IAMS allows data collection from multiple walk-over weighing devices that may be located in parallel “batteries” for measuring weights of animals moving in a single direction such as shown in FIG. 2C. Alternatively, the invention also contemplates the software/hardware being configured as shown in FIG. 2B where animals move in either direction, for example either to or from water or feed. The configuration of walk-over weighing systems can be in pairs to monitor in/out weights, but can also be in “batteries” monitoring animals in single directions both in and out of water or feeding areas.

In one embodiment, multiple weighing devices such as those illustrated in FIGS. 2B and 2C are linked to a single data logger (see below) such that data from each weighing device is transmitted to the processor, either sequentially or simultaneously. Linking data relating to the weight of an animal entering a feeding/watering facility with data relating to the weight of the same animal leaving that facility requires time gating to ensure links refer to a particular drinking or feeding event. Links between computers and communication systems can be wired or wireless, depending on the configuration and spatial distribution of the weighing devices.

A single weight measurement of an individual animal is of greater value if compared with previous weight measurements for that animal. Further information is gained by comparing its weight and weight change with similar data for animals in the same group. The position in rank order compared to other animals in the cohort group and the change in position with time provide valuable information with respect to health and welfare of the individual compared to others in the group. Mean weight change for the group can be useful in determining nutritional value of the pasture, supplement or prepared feed.

By way of example, a suitable algorithm has been developed to detect such changes in relative position with the main features that all previous weights of an individual animal and its group are used maximising the use of information. In addition the relative weight on recent or historic weight events can be varied allowing detection disease states that show different patterns of weight change during onset. The algorithm compares a new weight record for an animal with an expected weight that day calculated from (a) all previous records of that animal and (b) all weights in the database collected on animals within the same group.

The contemporary group of animals (cohort data) for this weight is calculated by selecting animals that were weighed with the same flock identification and weight dates as the current animal. This restricted data set is used to calculate the average weight of animals in the cohort group. Initially cohort data includes all animals from the flock. Since the heavier animals are sold as they reach market specifications the cohort average does not always reflect that of the original group. Thus, as the number of animals in each cohort group decreases a greater number of records per animal are typically needed to provide adequate accuracy of prediction.

The expected weight of an individual is calculated by combining information from the cohort group and all previous weights on a particular animal of interest. It is assumed that the data is being fed into the database in a serial manner and each record is processed at that point. Given n weighting events on a contemporary group (and n−1 on the current animal being evaluated) the algorithm used is as follows.

An array CGW_{i=1 . . . n} is calculated as the means of all animals in the contemporary group. wf is an array of weightings to be applied to successively older weights and is calculated as

$$w {f}_{i = 1 \cdot ( n - 1 )} = \frac{{c}^{( n - i )}}{{\sum }_{i = 1}^{( n - 1 )} {c}_{i}} \qquad ( 2 )$$

where c is a constant that is changes the emphasis on more recent weights as opposed to older weights and is tuned to the particular problem.

The relative weight of an individual (X) to its contemporary group is calculated as XR,
XR_{i=1 . . . (n-1)}=X_{i=1 . . . (n-1)}/GP_{i=1 . . . (n-1)} (3)

The expected value for an animal X on weight n is calculated as a weighted mean of the weighting factor (wf) and relative weight for all previous measurements

$$E ( {X}_{i = n} ) = {\sum }_{i = 1}^{( n - 1 )} ( {wf}_{i} \cdot {XR}_{i} ) \times {CGW}_{n} \qquad ( 4 )$$

This algorithm uses the average cohort weight and all previous weights of the individual animal to determine wether the weight of a particular animal at a specified time is within an expected range for an animal that is parasite and disease free. The same spline function is used to fit the cohort data however the expected value for the cohort is calculated differently from that of the individual. The calculation is performed in two steps.

First, the cohort average is calculated for all dates using a prediction from the linear model described above. A ratio of each weight of an individual and its contemporary cohort group prediction is then calculated. Following this calculation a weighted mean of the ratio is calculated. The weighting function is an autoregressive function across previous weights where each ratio is weighted by a constant to the power of the number of weights (wf),
wf_{i . . . (n-1)}=cons^{i . . . (n-1)} (5)
Ratio_{i . . . (n)}=X_{i . . . (n)}/GP_{i . . . (n)} (6)
where; Xᵢ is the weight of an animal on days I, GPᵢ is the group mean on each weighing event and Ratio_{i . . . (n)} is a vector of the relative weight of an individual compared to its mob across all weights. The slope of the individuals growth rate is then compared to the predicted cohort values and if there is a statistically significant variation between predicted and actual weight/weight change the ‘alarm’ signals action is required.

The form of action can vary depending on the extent to which the weight or weight change varies from expected. For example the animal can be ‘tagged’ for future checking or the particular animal can be drafted into a ‘hospital pen’ and an SMS message sent to the owner/veterinarian to alert them to the fact that sheep need to be examined for veterinary treatment.

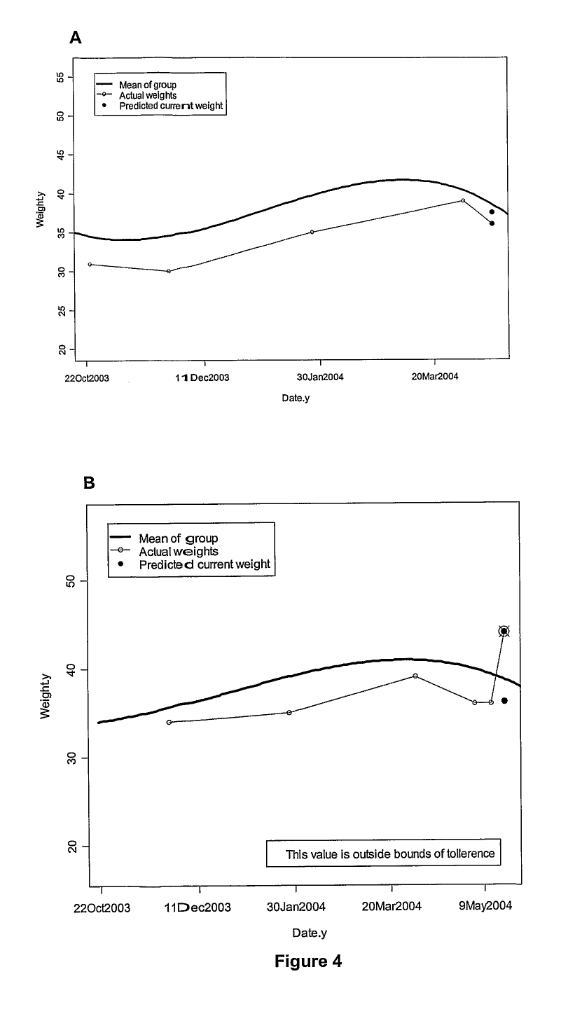

The basic framework of the above approach has been found to be robust when compared to actual historical data with all serial live-weights successfully used in screening the data for outliers. Examples of the application of this outlier analysis to individual sheep, namely the prediction of current weight of an individual based on the mean of group weight and past individual performance, are illustrated in FIG. 4. FIG. 4A shows weight over time for an individual where the predicted current weight using the above outlier analysis is within acceptable limits. FIG. 4B shows weight over time for an individual where the predicted current weight using the above outlier analysis is not within acceptable limits.

Weight change anomalies can be checked with historical measurements such as pregnancy status, number of foetuses, past wool production, wool quality, weather information and other real time measurements such as odour detection or video analysis to determine if combinations of physiological status, genetic potential, prior disease incidence or previous nutrition help to explain the change in weight or reinforce the urgency to act on the ‘outlier’ status of the weight measurement. The combination of one or more predisposing factors can significantly change the interpretation of the weight change information and the use of the database and disease algorithms are therefore important in determining the management decision.

Weight change and movement in rank (weight or weight change) can be used in conjunction with other measurements to determine parasite load. For example, animals with parasites, physical injury or a disease condition generally have reduced feed intake leading to reduced liveweight. Water intake can also be reduced in animals under these conditions leading to further weight loss. The energy cost of mounting an immune response and the associated increase in metabolic rate can lead to further liveweight loss. Weight monitoring and detection of weight changes of an individual animal relative to other members of the cohort group can provide an important indication of animal health and welfare problems that are difficult to detect by visual observation of a flock or herd of animals. Weight and condition change are particularly difficult to monitor visually in sheep since the fleece obscures appearance of rib bones and spinal processes that are indicative of poor and declining condition. Weight change is therefore an important parameter to monitor and analyse when monitoring a group of animals for health, welfare and production.

Of particular interest is poor weight gain or accentuated weight loss associated with the parasites including for example, but not limited to Trichostrongylus colubriformis, Trichostrogylus vitrinus and Ostertagia circumcincta and other non blood sucking nematodes. Measurements relating to weight and weight change can also be used for diagnosing infections by other parasites, for example Haemonchus contortus and Nematodirus spp. Animals infected by parasites and not resilient to parasite infection typically lose weight compared to animals that are not infected or are resilient to the infection. Analysis of weight change of an individual animal relative to its potential growth rate and other animals in the cohort group therefore allows diagnosis of parasitism in individual animals.

The mean weight of the group can be used to determine supplementary feeding practices and rotational grazing management. Animals that are below decide weights for production or reproductive purposes can be drafted to receive additional nutrients as a supplementary feed or can gain access to paddocks with better pasture before the main group. It is possible for sheep from more than 1 paddock to utilise a single AMM can be drafted between paddocks as required to achieve the desired weight gain or loss.

A typical method for using walk-through weighing or any regular weight measurement to monitor animals for parasitism may comprise initially treating all animals with anthelmintic in order to remove parasites and monitor weight change over a period of 3 to 4 weeks in order to establish potential growth rate of each animal and its rank in the cohort under conditions of zero parasite influence. Using the base information regarding growth rate potential and rank in cohort group, the subsequent growth of each animal can be assessed. At the time of each weight measurement (or aggregate measurement) the weight change for an individual is compared with its previous performance relative and that of the cohort group. Any animal underperforming by a pre-set margin can be drafted out for further specific diagnostic testing and/or treatment. The pre-set ‘trigger’ for identifying under-performing animals is dependent on the expected nature of parasitic infection and seasonal conditions. Different types of parasite and different dietary regimes result in different patterns of weight change, as illustrated in the Examples disclosed herein.

Air Sampling and Odour Analysis

Conditions such as blowfly strike, foot rot, diarrhoea associated with acidosis, diarrhoea associated with internal parasite infections, parasite conditions producing specific compounds such as blood in the faeces all have characteristic odours that can be analysed in order to produce discriminatory diagnoses of the various conditions. Separate algorithms are required for the odour associated with each condition. Each of the conditions that can be detected and diagnosed via odour analysis has secondary factors associated with them that aid in the differential diagnosis.

For example, animals with diarrhoea associated with grain-feeding typically have significantly reduced feed in-take, higher levels of water consumption and reduced body weight relative to normal animals. The combination of liveweight change, feed intake and water intake, together with odour analysis assists in providing a definitive diagnosis for fermentative acidosis. Similarly, sheep with blowfly strike will typically have a characteristic loss in weight and this may be associated with a rise in temperature. Again the combination of various changes in weight, feed intake and temperature can be combined with odour analysis to provide a specific diagnosis.

Samples of air may be taken from areas surrounding parts of an animal most likely to be affected by the various conditions. Samples are linked to the identity of the animal via the RF identification reader. For example, a sample of air may be drawn from around an animal as it walks through a walk-through weighing apparatus with appropriate sides to restrict air movement in the sampling area. A subsample of the airstream coming from the animal is then drawn through the odour detection device for analysis of the chemical profile via in-line sensors. In the case of diagnosing flystrike, samples of air are typically taken from around the back of the animal and around the tail and back legs. In diagnosing foot rot, samples of air are typically taken from areas adjacent to the feet as the animal walks across the detection device. For the analysis of the cause of diarrhoea, samples of air are typically taken from around the tail and back leg areas. The air sampling system is similar to that described for gas analysis above.

A number of techniques are suitable for measuring odour associated with disease and/or metabolic conditions in animal such as blowfly strike and diarrhoea. For example, arrays of sensors composed of conducting particles in a polymer matrix can detect a range of chemicals that when analysed together constitute specific and unique odours around. Additionally, equipment such as the Moses II with its various modules consisting of quartz micro balance sensors coated with different polymers and semiconductor sensors based on tin dioxide is commercially available, which can be calibrated to appropriate sensitivity for detecting blowflies, diarrhoea, footrot etc. Further, techniques based on nanotechnology involving semiconductor particles inserted into DNA or proteins offer great potential for specific detection systems. Research on DNA extracted from insects sensitive to odours associated with diseases and metabolic conditions of interest provide the basis for practical and cost-effective technology in the future.

Visual Observations

Operators, consultants and veterinarians can make visual observations in relation to the condition of any sheep and enter this on the on-site data storage device (described below) by a number of methods. This facility is enabled by the infrastructure of IAMS.

For example, for methods involving grading, such as condition score, dag score, wool cover over the face, frame-size, etc may be entered in the data-base in the following way:
The operator has a hand-held RF identification reader with an integrated control panel or keyboard with in-built data storage. This hand-held device can be used to read tags and enter the corresponding score for the parameter of choice. Data is subsequently down-loaded to the main database.
The operator reads the tag with a RF identification reader that transmits the data by wireless connection to the main data storage device and sends information in relation to the parameter via a separate hand-held wireless device.
The operator reads the tag with an RF identification reader and relays the information on score via voice recognition software using remote microphone with cable or wireless connection to the main data-storage device.
For subjective assessment and comments, the operator reads the tag using an RF device and then enters comments in relation to that animal via voice recognition software, transmitting this information to the main data storage via cable or wireless link.

For all the above, the data storage device may acknowledge receipt of information via audio response in the form of a sound or repeat of information.

Feed and Water In-Take Measurements

Measurements of individual animal consumption of trough water or supplementary feed may be made using any of a number of techniques. For example, when animals have access to feed or water one at a time, the identity of the animal can be determined by a panel reader accessing the RF identification tag and information linked to the volume of water measured via flow-meter or changing weight of the feed trough or water trough. Where animals have access to feed and water in groups, intake can be measured by linking the weight change of the individual animal prior to and following consumption of feed or water.

In a feedlot or intensive feeding system, intake of animals can be monitored by the change in weight of animals passing between feed and water and other areas of the feeding facility. Arrangements for handling large numbers of animals can be made by having parallel “batteries” of identification and weighing devices. The detection/weighing device either is able to detect which way an animal is moving over the device or unidirectional gates control the flow in a single direction in order to determine whether the animal is entering or leaving the water facility.

Those skilled in the art will readily appreciate that combinations of measurement of one or more of the above parameters may be used for a variety of detection purposes and for devising and for implementing management strategies. For example, as exemplified herein, combinations of liveweight change, feed intake changes and odour detection can be used to detect animals affected by blowfly strike.

Remote Video Surveillance

Facilitated by data communication and by having power available either through solar panels or mains power, it is possible to use remote video surveillance to monitor the functioning of the system of the invention as well as being able to check animals held in quarantine pens or to ensure that no animals are trapped in yards through malfunctioning of equipment. Remote video surveillance can also be used to check water and feed levels. Additionally, remote video surveillance can be used to focus on a specific pen, for example a quarantine pen, in order to assess the nature of, and the severity of, problems of the animals contained in that pen. According to an embodiment of the invention, a camera is mounted in a position where it can monitor the greatest range of activities and has the option of remote control over its direction, elevation and zoom. Images can be monitored via the internet through accessing the device via communications components of the IAMS.

2. Data Management and Decision Support Module (DMDSM)

With reference to the system of FIG. 1, following identification and measurement of real-time parameter data via the on-site raceside measurement and data capture 112, data is transferred, stored and analysed in the Data Management and Decision Support Module (DMDSM) 102. The DMDSM comprises On-Site Data Storage and Database

Management 113 and On-Site Real-Time Operational Decision Support and Implementation Software 114.

Typically, identification and real-time parameter data collected as an animal passes through the Animal Monitoring Module 101 is read, reconciled and stored on a data logger as part of the on-site data storage component 113.

(a) On-Site Data Storage and Database Management (113)

The data logger houses the software for integrating the RF identification reader/writer, electronic weigh scales, other AMM-facilitated measurements, data collected from other locations such as the shearing shed, and also contains certain historical information. The data logger unit may also house the software for communications with external/remote database servers and with operational ‘real-time’ decision support components of the on-site computer system. The data storage and database management component 113 also contains algorithms required for calculating animal weights, lameness, analysing separation distance and rank as well as other correlation software to facilitate detection of animals requiring treatment for parasite or disease conditions.

The data logger is typically a computer or similar device using a Windows, Linux or Palm operating system. Examples of devices are desktop or laptop computers, Handsprings and the IPAQ pocket pc.

Stored data may be correlated with historical data for the each individual animal. Further, the data storage and database management component may communicate with offsite databases for the purposes of uploading parameter data captured at other locations or available from other databases, expert systems or decision support services for downloading sheep profile data and to obtain information for the purposes of animal treatment and drafting. For example, a number of measurements of sheep are made at shearing time and at different stages of the production cycle that can be included in the database for use in correlations and development of algorithms as part of the decision support and implementation process. These measurements include:
measurement of fibre characteristics such as fibre diameter, fibre profile along its length using OFDA, FleeceScan or equivalent equipment, and staple strength;
fleece weight by electronic scales.
real-time scanning information to determine reproductive status and number of foetuses;
real-time ultrasound to measure eye muscle area connective tissue, intra-muscular fat and subcutaneous fat;
dates of birth, joining, weaning, etc;
results of parasite diagnosis made by measurement at site of sampling, directly on the animal or at an external laboratory;
physiological or metabolite measurements using electrosonophoresis, dipstick technology, spectrometry, haematocrit and/or temperature;
measurements made by subcutaneous, tissue or gut bolus implants;
measurements of faeces and rumen fluid for pararmeters such as pH, acid concentrations and a range of metabolites and nutrients;
algorithms linking the genetic potential of an animal, its expected growth path and response under different environmental conditions such as nutrition; and
scored or visually assessed characteristics that may relate to wool quality, body conformation, level of fatness or disease indicators.

Accordingly, the present invention enables the correlation of multiple measurements, taken at different points in time, and at different locations, for the development and implementation of a single integrated management strategy for individual animals.

The data collected and stored may also include records of management actions such as chemical treatment for internal and external parasites, crutching, mulesing, castration, feeding and like activities relating to specified animals on certain dates. These data may be used in conjunction with other information for future management decisions such as breeding selection, nutrition and marketing.

In a particular embodiment of the invention, the on-site database is configured to accommodate inputs from the Animal Monitoring Module 101 as well as from external data collection and thus has the capacity to transfer data via landline or wireless technology to other locations and data management modules as well as having the capacity to drive implementation software and hardware such as automatic drafting/sorting equipment.

Communications between the data storage and database management component and offsite databases or other data sources may be achieved using fixed line technologies such as Ethernet, land phone lines and wireless technology. Wireless technology bearer protocols include CDMA1/1X, GSM/GPRS, WLAN (802.11b), UHF, Bluetooth and satellite communications. Communications may also involve cross bearer protocol communications. For example, the IAMS may use a CDMA modem to communicate with a fixed land line modem at the database server or a GPRS modem to establish an Internet link from the AMM facility to the database server.

The content transport protocols can be one of FTP, HTTP, TCP/IP Sockets, WAP, and SMTP or any other suitable protocol. For example, current IAMS use a CDMA modem at the AMM facility to communicate with the database server. Data is then transmitted using a proprietary protocol that utilises check sums for data integrity. Communications between facilities can be done in real time or in batch mode. Standardised data transfer is assisted through development of a data dictionary for each aspect of the product and value chain.

(b) On-Site Raceside Real-Time Operational Decision Support and Implementation Software (114)

A central component of IAMS is the real-time operational decision support component 114 that takes data from a range of sources including the following:
the on-site database 113;
remote management and advisory decision-makers;
remote decision support systems such as centralised genetic evaluation units; and
external data such as market information and benchmarking data from other locations.

In a particular embodiment, the operational decision support unit also has the task of controlling the computer directed drafting and treatment component 115 in the Implementation and Management Module 103 (described below). This requires specific operational (real-time) decision support that makes operator-guided decisions about the management of each individual animal based on all information available on its performance, well-being and the opportunities for its sale at time of measurement as well as management requirements to meet future market specifications. The available data are used by the on-site real-time decision software in order to implement a decision on the management of the animal. Software and algorithms for use in accordance with the present invention are typically applicable to real time data analysis. As data continues to be collected, population parameters (mean, variance, truncation points) are updated for each measured trait. The result is that a management decision can be made for each animal regardless of the proportion of the whole flock that has been recorded at that point in time.

A decision may typically involve three primary decisions:
(i) animal requires health and welfare management and treatment;
(ii) animal requires nutritional supplement; or
(iii) no treatment required.

The on-site real-time operational decision support component 114 can also include optimising routines for single, dual or multiple production/product options, for example determining the most profitable management strategy for each animal and the most appropriate group sizes depending on the resources available (such as size of trucks, feedlot capacity, labour units required per activity).

A detailed description of how decisions with respect to animal health and welfare and supplementary nutrition are made are provided below.

Transactional Use of Data

Information in the system database in relation to current and past weights of animals, together with projected growth based on pasture conditions and seasonal trends, can be made available to buyers via the internet. This information allows buyers and processors to make offers for animals when they are actually being weighed on farm and can arrange a mutually acceptable time to collect animals.

Information on live-weights made at regular intervals can be good predictors for products such as wool. Through experimentation, predictive relationships are derived allowing prediction of wool quality and particularly staple strength on the basis of pattern of live-weight change during the year. Sheep that maintain an even live-weight through key parts of the year are known to have sound staple strength and this is of greater value to the purchaser. In this way, continuous monitoring of weight provides buyers with information that allow them to bid on wool while it is still on the sheep. Live-weight change is also an important indicator of meat quality as animals that are growing prior to slaughter have higher levels of glycogen and better meat quality than animals that are losing weight. Information made available to processors and buyers allow purchase on the basis of weight and weight-gain at time of purchase.

Data provided by buyers and processors by way of a price-grid set discriminators for drafting decisions and management input at the farm level. This two-way flow of information is managed via the wireless links described above.

The data collected on each animal during its period on a property or feeding facility is often of value to the buyer and can be transferred to the new owner at time of sale as part of the sale price or in consideration of additional charges.

The transactional information on price and time of transaction can be accessed by financial advisers to the property in order to provide up-to-the-minute information on cash-flow and taxation matters. The information is also used to update all genetic and management records linking performance and return on animal to its breeding and management. Pre-setting of management criteria for on-farm decision making can involve off-farm management input as well as professional advisory services. These decisions can over-ride the optimisation and operational decision systems or provide additional information for consideration during on-site drafting and handling. Examples of outside input for management systems includes that provided by geneticists; parasitologists; veterinarians; marketing consultants; accountants; and nutritionists. This external input can be made directly into the decision support software via the wireless links connected to the internet. The information can also be relayed to the point of management/sorting by conventional paper-based means and entered by the operator on-site.

Setting Decision Criteria

In its simplest form, a decision criterion can be based on a single measurement such as a measure of liveweight. More commonly, the decision will be based on a combination of data processed through computer software. Some examples include:
information from multiple traits (fleece weight, fibre diameter, body weight etc.) combined into a numeric value or index that is used to decide whether an animal is chosen into the flock or culled for sale;
ewes designated to a particular mating group based on their measured performance and pedigree to maximize economic value and minimize inbreeding in the progeny;
parasite treatment for a particular animal determined from its assessed level of susceptibility to infection and previous treatment history;
order of shearing for animals nominated by their ranking on fibre diameter to assist in clip preparation; and
slaughter group identification based on previous body growth and assessed level of fatness.

Despite numerous decision points for management of groups of animals that can be based on an analysis of stored production data, the algorithms to derive specific criteria are similar in concept. A quantitative “index” is derived on which animals can be ranked and then appropriate cut-offs specified to set up the groups. The “index” may be a single trait (such as fibre diameter), a group of traits (multiple body weights) or a predicted date for reaching a specified production level. Commonly, such “indexes” are based on a regression analysis. Software algorithms have been developed for many applications. A particular application is an optimization procedure that combines production data with external price information to maximize profit in the use of wool measurements for clip preparation or liveweight records for optimized slaughter groups. A further application involves procedures for making decisions in real time, that is at the time of measurement of an individual, rather than waiting for measurement on all animals to be available before analysis.

External Data to Support Decision Making

Apart from information on an individual animal, external data can be a powerful source of information to aid decisions. Examples of such external data include: market information for livestock and livestock products; costs associated with various options for buying and selling livestock or livestock products; benchmarking health and performance; estimation of feed on offer and estimates of feed production; feedback from processors and agents etc; prices of commodities such as feeds and feed supplements fertilizer; cost and availability of animal health inputs such as drenches and vaccines; costs of contract services such as drafting, fibre measurement, pregnancy scans, transport; and costs of various testing and certification procedures associated with product authenticity and/or production monitoring.

Optimisation procedures can combine production information on animals with current prices to maximize profit. For example, measurements of fibre diameter can be combined with market price curves to derive the optimal separation of fleeces into sale lines of wool. The analysis determines the diameter cut-offs for use in the shearing shed to prepare the clip. Similar approaches can also be used to determine which groups of animals will most benefit from the application of sheep coats or specialized grazing management for improved wool quality, or to determine the most appropriate break-up of slaughter groups to maximize returns for a given market grid of prices.

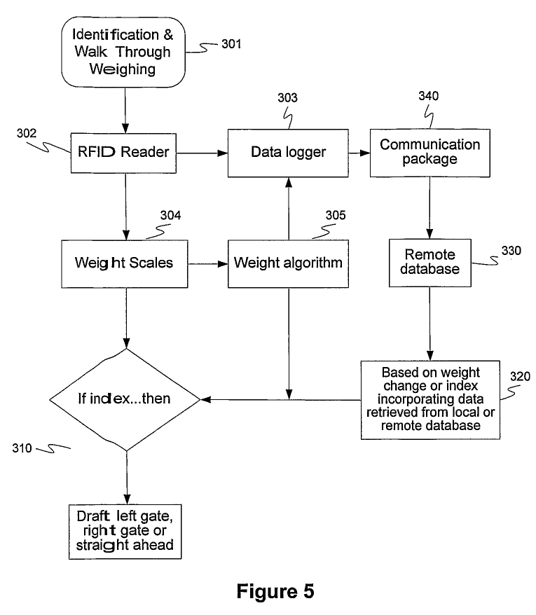

It may be advantageous to integrate parameter data and information available at point of collection in the AMM facility with externally derived data and information. For example, FIG. 5 provides a schematic summary of how this integration may be achieved for liveweight data. As sheep enter the walk though weighing unit 301, the electronic identifier (EID) on the RFID tag of each animal is read using an RFID reader 302. The EID is stored in the data logger 303. The sheep proceed over the electronic weigh scales 304. The electronic weigh scales stream weights to the data logger 303. The data logger 303 contains an algorithm 305 to calculate an actual weight for an individual animal from the streamed weights. The actual weight of each animal is then stored in the data logger along with the previously read EID. After leaving the electronic weigh scales the sheep approach a drafting mechanism 310. The drafting gate will open in an appropriate direction based on specified decision criteria 320. For example, the actual weight stored in the data logger for each sheep may be compared to previously uploaded drafting criteria from a remote database 330 to reach a drafting decision, or alternatively a decision may be made using a previously uploaded drafting profile from the remote database 330. Any of these drafting mechanisms may be assembled using Decision Support Software on the remote database 330. The communication package 340 is software on the data logger 303 responsible for uploading EID's, weights and other auxiliary data to the remote database 330. The communications package 340 can also download drafting and treatment profile data to the walk through weighing system.

Remote Decision Support

Some decisions can be improved by access to remote decision support systems. One example is genetic evaluation where the use of related animals in other flocks can improve the prediction of genetic value of an individual animal. The support system is unchanged in that data is transferred (electronically) to the genetic evaluation service for combined (across-flock) analysis and then returned to the on-farm database in analysed form. Decision analysis on-farm proceeds as described above except using the derived analysis rather than the raw data collected on farm. A further example relates to the use of decision support to determine structural components of the enterprise such as optimal stocking rate, lambing time or flock structure. Such software exists remotely (such as GrassGro) and can be customised to use production parameters of the farm enterprise as provided by the on-farm database. The relevant results from simulation models can then be used for strategic decisions on enterprise structure.

Phenotypic Assortment of Animals

It is often desirable to draft and implement management strategies for animals on the basis of multiple trait measurements. For use in embodiments of the present invention, an algorithm and software have been developed for simultaneous selection on two traits in sheep—a meat and a wool “index”. The meat index may simply be a body weight or meat value containing carcase weight and fatness, while the wool index may simply be fibre diameter or a wool value containing price and fleece weight. The software enables the user to determine the number (or percentage) of animals to be removed for culling and the percentage of animals to go into the meat or wool groups (the “summary” sheet). The draft for the animals can be displayed next to each individual animal. The average fibre diameter, body weight and values are shown for each assortment group.

The body weights and fibre diameters, or the meat and wool values, are automatically incorporated into the “calculations” program from the “summary” sheet. The assortment of animals using meat or wool selection procedures comes directly from these values. For wool selection the animals are ranked according to their diameter or wool value. The animals with the lowest diameter (or highest wool value) are used for the wool flock, the highest diameter are removed as culls and the remainder of animals are used for the meat flock. The percentage allocated to each of these flocks is determined by what was entered in the “summary” sheet. The meat selection is calculated in a similar way. The animals are ranked according to body weight or meat value. The heaviest (or highest meat value) animals are used as the meat flock, the lightest as culls and the remainder for the wool flock.

The simultaneous assortment of the animals into the meat or wool flocks requires further calculation. The average and standard deviation (SD) for the body weights/meat values and fibre diameters/wool values are calculated. Standardised values are then calculated for body weight and fibre diameter for each individual animal as follows:
(Actual trait measurement)−(mean of trait for the flock) (SD of trait for the flock)

An index (“select index”) is then calculated from these standardised values to determine to which group each animal is more suited. The index is the two standardised values added together. When this index is ranked, the higher ranked animals are more suited to the wool flock (low FD, low BW), whilst the lower ranked animals are more suited to the meat flock (high BW, high FD). Another index is needed to calculate which animals need to be removed for culls.

The above procedure can be readily extended to allow real-time selection at the time of measurement of either or both of the wool and meat traits.

3. Implementation and Management Module (IMM)

Based on the data available from past and real-time measurements on an animal considered in conjunction with external information and a range of pre-set algorithms as discussed above, decisions can be made about the management and treatment of individual animals via the Implementation and Management Module 103; comprising a Computer-Directed Drafting and Treatment component 115 and a Data Update component 116.

(a) Computer-Directed Drafting and Treatment (115)

Implementation of a management decision is typically made using an automatic drafting or sorting machine. Such sorting/drafting machines normally involve mechanically controlled gates that guide sheep into enclosures or races. The number of drafting or sorting options can vary from two to an infinite number, with the normal range being between two and five directions. Mechanical control of the gates can be via a number of suitable means, for example air-rams, electrical motors or change and cog devices. When operating in remote locations particular requirements for low energy consumption dictate particular designs for these drafting machines. In these circumstances, options include solar-powered systems which revert to straight-through flow of animals when there is insufficient solar radiation, low input electrical motors and combinations of electronic and mechanical devices where the mechanical devices are activated by the animals weight moving over a platform attached to levers or by pushing on levers that activate gate systems in other parts of the race system.

Automatic drafting systems are widely available that draft animals only on the basis of current live weight relative to preset targets. The computer-directed drafting and treatment component 115 of the present invention integrates information on the identity of the animal with directions from the on-site raceside real-time operational decision support and implementation software 114 of the Data Management and Decision Support Module 102.

This sophisticated integrated system allows for a wide range of management decisions and treatments depending on the current status of each animal and its future potential. Two main areas for intervention and management are: animal health and welfare; and selection/drafting for routine production management activities.

In terms of animal health and welfare management and treatment, animals requiring additional nutrition may be drafted to feeding systems that provide either specific nutrients such as proteins or introductory diets. Alternatively animals may be drafted to feeding systems with a grain based production diets. Animals with health problems may be drafted for automatic treatment involving medicated feeds for control of internal parasites or systemic bacterial problems. Animals diagnosed with external parasite problems or with footrot may be drafted for spraying, backline chemical application or walk through chemical treatment for footrot. Animals diagnosed with serious or recurrent problems of underperformance or health issues may be drafted into a quarantine pen where they await inspection by the manager or veterinarian. In this case, the manager may be notified of such animals requiring attention by SMS messaging or equivalent.

With reference to production management activities, animals with satisfactory growth or performance may be directed to continue through to the current paddock or feeding system and animals with characteristics that meet market expectations may be drafted for sale. When animals need to be sold in order to reduce stock numbers, those animals of least value to the ongoing production systems and of greatest value under the current market conditions may be identified and drafted for sale. Additionally, animals may be drafted into management groups for consolidated management, for example where efficiencies are required or there is a need to deal with animals of similar characteristics in cohort groups such as shearing sheep of similar wool characteristics. Further, animals may be drafted into mating groups to optimise genetic gain from the best use of combinations males and females.

Animals Requiring Attention for Animal Health

Animals requiring detailed diagnosis may categorised by non-specific weight-loss or severe weight loss not responding to previous treatment. These animals can then be drafted into a quarantine pen with the and an SMS message or equivalent sent to the manager or veterinarian, indicating how many animals are in the quarantine pen requiring diagnosis and/or treatment. Animals drafted in this direction may require treatment for internal parasites based on weight-loss in the absence of nutritional stress or other identified problems. The treatment can be administered, for example by: consumption of medicated feed containing one or more anthelmintics and/or antibiotics; water medication containing one or more anthelmintics and/or antibiotics; or drafting into a specific pen for oral drenching by a manager/veterinarian.

Animals so drafted may also require treatment for external parasites. Depending on the nature of the external parasite, specific treatments can be applied. For example, for blow-fly treatment, chemicals can be sprayed or applied via a dripline down the back of the animal. For conditions such as footrot, sheep can be drafted to walk through a foot bath containing zinc sulphate or formalin for a specified period of time, for example every 7 days or 14 days, depending on the nature of the chemical used.

For animals identified as requiring additional nutrition, the animals may be drafted to a paddock or pen containing improved pasture or feed, the animals may be provided with specific feed supplements, or placed on production feeding.

(b) Data Update to Document Treatment Procedures (116)

Following any of the management practices coordinated by the computer directed drafting and treatment process 115, database records need to be updated to reflect the most recent management inputs.

For example, updated records are of importance for verified chemical use and its impact on withholding periods prior to sale as well as for determining “chemical free” status for specialised “organic” markets. The updated information on each animal is also used to accompany that animal to the purchaser so that the future owner can derive maximum benefit from information already available on each animal. The database may also organised as such a way that information from the subsequent owners of the animals or the processor can provide feedback data to the property or operation where the animals were bred so that this information can be incorporated into future decisions on genetic selection and management. In addition, the database may be used for animal welfare assurance for markets and regulatory authorities, providing hard data on the health, weight gain and veterinary treatments of the flock.

Post Farm Data Tracking and Feedback

Individual animal identification in the form of RF identification or the equivalent may be used to track individual animals and animal products through the abattoir, processing works, through to wholesale and retail outlets. The links using RF identification, bar-codes or equivalent, provide a fall record of information on a particular animal and its products from the farm through to the consumer. Data from throughout the product and value chain provides a variety of information of value to the industry. For example, product authenticity information provides certification for the consumer in terms of origin of the product and can also provide certification of organic or chemical-free status for products from those animals that have received no chemical treatment throughout their life. The information through the value chain also provides the ability to trace back any product in relation to an issue of contamination or any aspect of quality and identify the point at which the problem occurred in order to correct and prevent any repeat problems. Further, the data collected through the value chain to consumers provides valuable information for producers, breeders and processors in terms of management practices and the genetics required to meet consumer expectations in the most productive and profitable way.

Electronic Product Code standards

The Electronic Product Code (EPC) is the electronic equivalent the bar-code system enabling identification and recording down to the level of single items. The EPC initiative has generated a uniform set of standards throughout Europe and the United States of America, and is becoming adopted as the global standard for labelling objects with radio frequency identification (RFID) devices. Simultaneously standards and authorization protocols have also been developed for the Object Name Service (ONS)—registering directories containing EPC data. Similarly search engines and protocols for searching ONS and related EPC information systems (EPC-IS) have been developed. The links between RFID for identifying objects, EPC to accord individual objects a unique identification, and standards for sharing information and conducting transactions relating to such objects via the internet (ONS and EPC-IS) provides smooth access to information in the databases of manufacturers, warehouse operators, transport companies and retailers.

In facilitating the tracking and management of animals, and animal products, embodiments of the present invention are readily implemented in compliance with EPC and ONS. In many circumstances this compliance is desirable as the EPC Global Network standards form the basis for future supply chain management, being accepted by all major retailers and manufacturers and the links between RFID, EPC and the internet also provide a mechanism for ensuring product authenticity and trace back.

While a product code need not necessarily be ‘hard-wired’ into each RFID tag for individual animals, the information in the information storage system may be standardized such that the coding of information on the RFID tags is consistent with EPC protocols.

The present invention will now be further described in greater detail by reference to the following specific examples, which should not be construed as in any way limiting the scope of the invention.

### EXAMPLES

### Example 1

### The Detection of Blowfly Strike Through Odour Analysis

Sheep grazing during summer rainfall conditions are susceptible to blowfly strike and its detection is of significant economic importance. During periods of risk an electronic nose is included in the walk-through animal monitoring system. Samples of air are taken from along the back of the animal and from around the tail and back leg region. Information on the air analysis is linked with database records of live weight change and changes in the ranking of live weight and live weight change relative to other animals in the flock and other flocks in the region. Sheep diagnosed as having fly strike are drafted through a race fitted with either a spray or a backline pour on treatment. A record is made of the treatment in the on-site database. If the same animal is detected with evidence of odour associated with blowfly strike two days after initial chemical treatment then it is drafted into the quarantine pen and the manager or veterinarian is notified by CDMA or SMS messaging.

Monitoring of blowfly odour in the flock continues for the period during which risk exists. Blowfly monitoring equipment therefore lends itself to lease or hire arrangements where it can be moved from property to property depending on the level of risk existing in a particular area.

Blowfly Strike-Liveweight and Feed Intake Changes

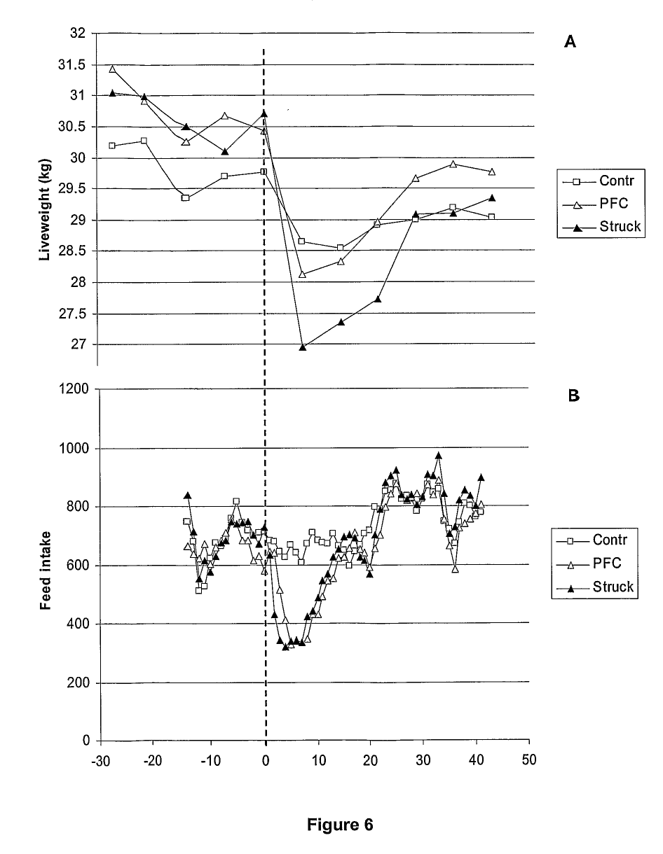

Three experimental groups of sheep were studied to examine the effect of blowfly strike on weight and feed intake levels. The first, ‘Control’, group had no blowfly larvae and were allowed free access to feed. A second group ‘Struck’ were infected every day for a week with blowfly larvae and had free access to feed. The third group ‘Pair fed controls’ (PFC) were uninfected but fed an amount of feed equivalent to the ‘Struck’ sheep. All sheep were weighed weekly. As shown in FIG. 6, the ‘Struck’ animals, infected with blowfly larvae, consumed significantly less feed than the ‘Control’ sheep and lost more weight during the first week than the ‘Control’ or ‘PFC’ groups.

These results illustrate how regular weighing of animals and analysis of individual weight change relative to past weight change and weight change of the cohort group can be used for identifying animals in need of treatment. Weighing of animals can be via conventional means or by automatic walk-through weighing. Identifying animals needing treatment is made possible using the outlier analysis algorithms disclosed herein.

Blowfly Strike-Odour Detection

Certain disease conditions in livestock are associated with characteristic odours linked to specific volatile chemical compounds. These odours can attract blowflies and therefore indicate animals at risk of fly strike and can also be indicative of disease conditions such as flystrike, footrot and internal parasite infection.

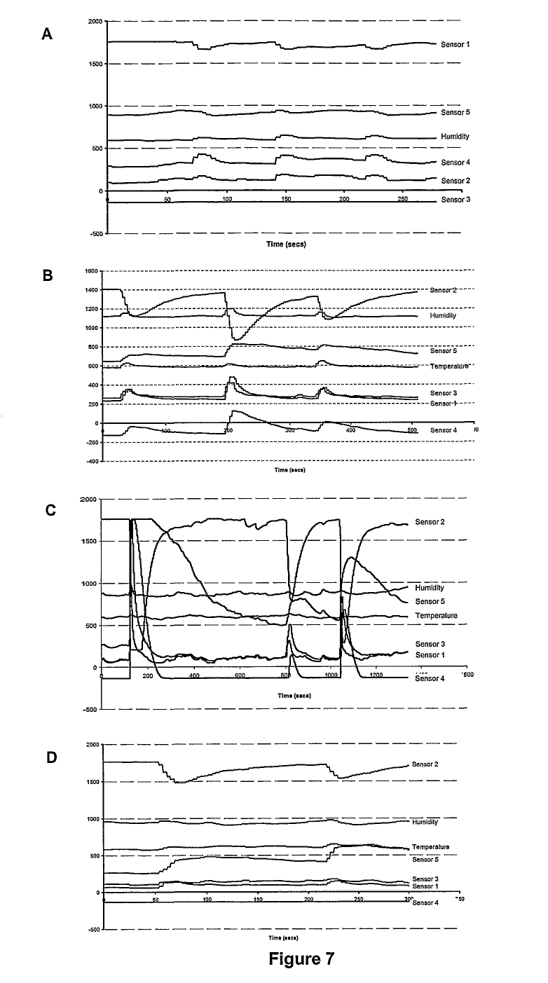

Results of tests using an electronic odour detection device (supplied by E-Nose Pty Ltd) to examine clean wool from normal animals, pads taken from an area of sheep skin with lesions from blowfly larvae, matted wool containing faeces and urine (dags) and bacterial cultures from sheep affected by fleece rot are summarised in FIG. 7. Traces show the responses of five chemical sensors as well as temperature and humidity when testing the four flystrike-related samples. It is clear that the magnitude of the response of different sensors and ‘fingerprint’ of the various responses is specific to the type of sample tested. While there is little if any response of sensors to clean wool (FIG. 7A) there are significant and characteristic responses to flystrike (FIG. 7B), dags (FIG. 7C) and fleece rot (FIG. 7D). These results therefore demonstrate that odour analysis can be used to identify animals at risk or suffering blowfly strike—the traces in FIG. 7B, 7C and 7D are sufficiently different from that of FIG. 7A (clean wool) to provide the basis for remote detection of animals at risk or infected with blowfly larvae.

Combining Weight Change and Odour Analysis for Diagnostic Decisions

While changes in either liveweight or odour profiles on their own present useful opportunities for remotely identifying and managing animals to prevent or treat blowfly strike the detection of concurrent changes in liveweight and odour allows more precise and earlier diagnosis and treatment than possible when any one parameter is considered on its own.

A preferred method for blowfly detection therefore involves animals walking over a weighing platform where air samples can be taken and analysed simultaneously with weight measurements and identification of the animal's identity via radio frequency ID tag. The information is interpreted by on-site computer and animals identified as being at risk are drafted to a ‘hospital pen’ for treatment. Information about the number of animals in the hospital pen is sent via wireless modem/internet connection to manager/owner and/or veterinarian.

### Example 2

### Detection and Management of Internal Parasite Infections

Two parasite groups that are of significant economic importance in sheep management and production are Haemonchus contortus and the “scour worm” group (main species: Trichostrongylus colubriformis, T.vitrinus, Ostertagia (Teladorsagia) circumicincta and Nematodirus species). Haemonchus is a parasite of the abomasum and sucks blood from that part of the digestive tract. Severe infections with Haemonchus result in severe blood loss, acute anemia and death. The development of severe haemonchosis is rapid and animals can die within weeks of a severe infection. Trichostrongylus and other “scour worms”, on the other hand are parasites of the gastrointestinal tract that cause decreased efficiency of feed utilisation, slightly reduced intake an sub-optimal performance over extended periods. Infections of “scour worms” is usually chronic and does not cause the same acute problems and risk of death associated with haemonchosis.

### Example 2a

### Diagnosis and Treatment for Haemonchosis

Sheep grazing pastures in an environment endemic for H. contortus pass through a remote individual animal management system (RIAM) on a daily basis as they move to and from water. The weight of each animal is recorded and there is scan of the facial tissue and eye using remote image analysis linked to the RIAM in order to monitor haematocrit (anemia) on a daily basis. The database in the computer linked to the RIAM contains information about the historical performance of each animal and updates information on weight change, rank in group for weight and weight change, as well as rank in group for haematocrit score. Animals that have a sudden change in their absolute reading and in their performance relative to other animals in the flock are drafted to the quarantine pen via the automatic drafting system and a message sent via CDMA modem to alert the manager and/or the veterinarian to the fact that there is a need to check animals in the quarantine pen. Information is transmitted on a regular basis in order to be able to monitor the number of animals requiring treatment. The manager or veterinarian is able to download information on the sheep drafted into the quarantine pen and use this information together with a physical examination to determine the appropriate treatment. Treatment options are to have animals starting to decline in body weight and haematocrit drafted to a pen with supplementary feeding available each day to assist the animal overcome the parasite burden through nutrition-enhanced activity of the immune system while being monitored closely. The second strategy is to drench the animal with an anthelmintic. All records of treatment are stored in the database.

Weight Change Associated with H. contortus Infection in Sheep

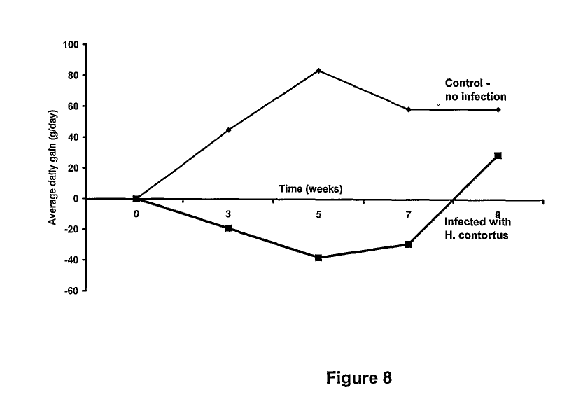

As shown in FIG. 8, sheep infected with H. contortus have a significantly different growth rate than control animals with no parasites within 3 weeks of infection with the parasites (obtained from Datta et al. (1988) International Journal of Parasitology 28:1269-1278; data recalculated for present purposes). Such a correlation can be used in devising and implementing management strategies via RFID tags to identify animals in combination with automated walk-through weighing to allow measurement of individual animal weight change at relatively low cost. The use of weight change data for diagnostic purposes is facilitated by use of the algorithms (for example as disclosed herein) for weight change analysis that enables comparison of weight change performance of each individual animal with its own previous performance, that of the cohort group, and its changing rank in the cohort.

### Example 2b

### “Scour Worm” Infection

“Scour worm” infection is diagnosed by animals grazing under the same conditions as described above for Haemonchus and with the same AMM facility. Gradual loss of performance is seen through lower growth rate or faster weight loss are triggers for further analysis. The first test is to examine whether there has been a change in haematocrit. If there is no decline in haematocrit, the animal is diagnosed not to have Haemonchus and highly likely to have Trichostrongylosis or other “scour worm” infection. These animals can be drafted to a paddock containing medicated feed, where they will have one meal of feed containing anthelmintic. Subsequent performance is monitored and if there is no improvement in condition, animals are drafted into the quarantine pen and the manager alerted to examine the animals, with a view to additional treatment. Animals detected as infected may also be drafted into a group for specific nutritional supplementation to boost natural immunity to nematode infection. Odour analysis over several days for diarrhoea detection can be used on its own or in conjunction with the diagnostic tests outlined above.

Odour Detection for Management of Ostertagia circumcincta Infection in Sheep

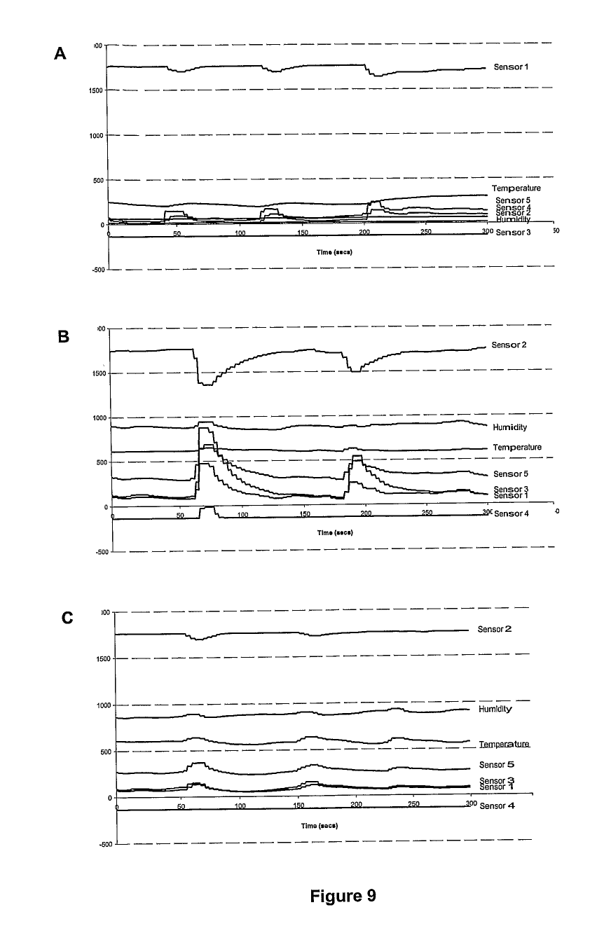

Samples of faeces were obtained from groups of sheep on the same dietary regime but with different internal parasitic infection. These samples were examined using an electronic odour detection device (supplied by E-Nose Pty Ltd) and the results are shown in FIG. 9. The ‘Control’ animals (FIG. 9A) had no parasites, and the other two groups either had Ostertagia circumcincta infection (FIG. 9B) or Haemonchus contortus infection (FIG. 9C). There was little response in the sensors to the presence of faeces taken from the ‘control’ and Haemonchus contortus groups. However there was a significant response in the sensor array for odours associated with faeces from sheep infected with Ostertagia circumcincta (FIG. 9C). These results indicate that electronic odour detection devices designed with appropriate sensors can be used for diagnosis of Ostertagia circumcincta infections in sheep.

A preferred method of collecting samples of air has been described above in Example 1 for monitoring blowfly strike. A similar method can also be used in monitoring for Ostertagia circumcincta infection. Further use of the odour detection equipment may involve placing a sample of faeces in a jar or other container and drawing air past the sample for analysis. This form of sampling is suited to raceside applications and laboratory tests.

As for blowfly strike, diagnosis of animals with internal parasite infection, where the parasite is Ostertagia cricumcincta, can be based on weight changes and odour detection. The different odour traces for Ostertagia cricumcincta infection, blowfly larvae, fleece rot and dags can be used to achieve differential diagnosis.

In each of Examples 2a and 2b above, information on pregnancy status, genetic information on the expected growth path, past drench and disease treatment and factors associated with the value of the animal can be considered in determining treatment for the animal. Animals that repeatedly require anthelmintic treatment can be drafted off and sold.

Nematodirus spp. can cause reduced growth rate or increased weight loss in the same way as described above for Haemonchus, Ostertagia and Trichostrongylus. Analysis of weight change of individual animals relative to their own historical performance and the past and current performance of animals in their cohort group therefore provides the same basis of diagnosing parasite problems requiring treatment as described for Haemonchus and Ostertagia and Trichostrongylus.

### Example 3

### Treating and Eradicating Footrot

Not all of sheep within a flock suffer from footrot. If footrot is present or suspected the footrot odour analyser is installed in the walk-through animal monitoring system. The air intake for a sample collection is positioned placed close to the feet as the sheep moves over the platform. The data from this test are combined with information on the live weight gain/loss and changes in the rank position of the animal relative to others in the flock. Animals with lower than expected live weight performance and with evidence of odour associated with footrot are drafted into a race that contains a foot bath filled with chemical solution appropriate for treatment of footrot. Details of the animal and chemical treatment is retained on the database both for use in disclosing disease status of the flock and for information on possible chemical residues and withholding periods governing sale animals for human consumption.

### Example 4

### Managing Animals During the Reproductive Cycle

Twin-bearing ewes require more nutrients than single bearing ewes and single bearing ewes require better nutritional conditions than ewes that are not pregnant. Approximately six weeks after mating all ewes are scanned using real-time ultrasound imaging in order to determine whether they are pregnant and, if so, how many foetuses are present. At the time of scanning, information on pregnancy status and number of foetuses is entered into the database corresponding to each animal. Depending on the pregnancy status and number of foetuses each ewe has an optimal growth path during its period of pregnancy until lambing. Algorithms by used to enter the desired growth path for each animal. During pregnancy ewes passing over the animal monitoring are weighed and if the weight is below that considered optimal by more than 5% of the target then the animal is drafted into an area where it is able to receive a supplementary feeding. The animal requiring supplementary nutrition can receive this either through free access to a self feeder or can be given a number of aliquots of pre-weighed feed. Once the animal departs from the feeding area to take water it is not able to return to the feed area until drafted into that the feeding area again on the basis that its live weight is still below optimal.

An alternative to having a self feeder or administering aliquots of a supplementary feeding is to draft the animal into a different paddock with either more or better quality feed. The time that the animal has access to the paddock with better feed can be determined by the real-time decision support software. It is possible for animals grazing in two separate paddocks to share one water trough and the same animal monitoring/drafting equipment. In this way animals have access to the improved pasture conditions for as long as their weight stays below that considered optimal for their pregnancy status. Similarly animals that have live weight above that considered to be ideal for their pregnancy status can be drafted on to poorer pastures until their weight reaches the target. At that time the animals can return to grazing higher quality pastures.

### Example 5

### Managing Animals Under Intensive Feeding Conditions

Under feedlot conditions, troughs with feed and water troughs are normally located at opposite ends of the enclosure. Animals regularly move between the feed and water troughs. Monitoring of the animals is possible by placing animal detecting and weighing systems between the feed and water. The system and makes it possible to record changes in weight of individual animals in response to water and/or feed consumption. Additional information relates to monitoring rate of live weight change in individual animals. These data can be used to identify animals that are not consuming satisfactory amounts of feed for appropriate weight gain and these animals can be drafted out of the feedlot in order to save cost of feed in animals unlikely to meet market specifications within the time constraints.

Similarly, the data on individual animal live weight gain can be used to predict the time that each animal will reach its market weight. This information enables the manager to schedule transport and make arrangements to sell animals in optimal size groups for the purchaser. Information on the performance of each individual animal is provided to the breeder. Further value is added to this information on performance in the feedlot by linking information collected in the abattoir. Abattoir information linked to the RFID or similar identification of the animal can include carcass information, muscle yields, fat cover and any animal health observations.

### Example 6

### Improved Animal Welfare Management and Welfare Assurance

The management of animal welfare is an increasingly important tool for livestock industries in terms of meeting consumer and market requirements, and addressing the expectations of the general public and regulatory authorities. Animals under practically all management systems (intensive feeding, extensive grazing, supplementary feeding, preparation for live export) will include a minority of animals that require special management. These animals can be identified before signs of serious discomfort or morbidity develop and animals can be treated before animal welfare becomes an issue.

Animals passing through the AMM and found to be losing weight relative to other animals under the same or similar conditions are drafted/sorted for special attention. In particular animals that do not pass through the AMM because they have temporarily stopped eating or drinking or have other problems hindering normal movement or normal social interaction with other animals are identified and the manager alerted via a messaging service so that the animal can be treated. Welfare triggers can be set using a single measurement, a number of criteria and can take account of parameters such as stage of pregnancy, number of foetuses and other relevant information. In addition, by tracking weight changes of the flock, the system allows automated management of animal welfare during challenging conditions such as drought, and targeted supplementary feeding and health management. Most importantly, the data generated by the system is used to provide information on animal welfare management by the producer for purposes of welfare assurance for high-value markets.

### Example 7

### Nutritional and Animal Health Management via IMM

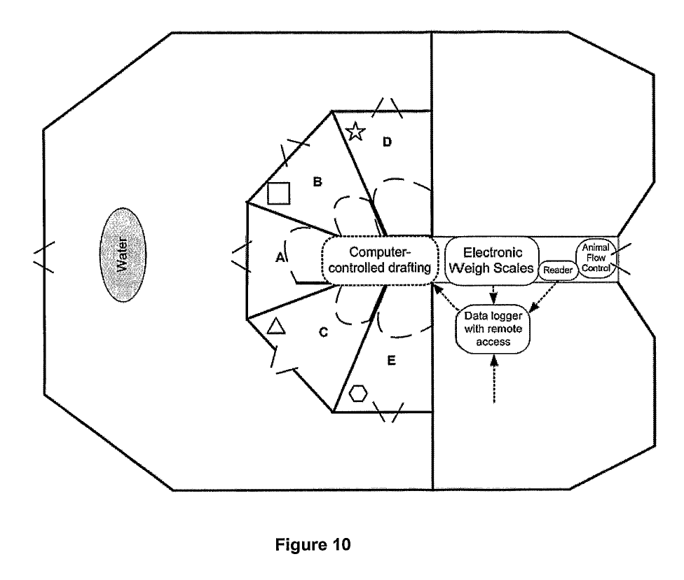

FIG. 10 illustrates an embodiment of an IAMS of the invention in which computer-directed drafting is used to implement a management strategy based on the walk-through weighing of animals as described above. Sheep entering the electronic weigh scales and AMM facility are identified, monitored and information reconciled with records on the data logger and any remote information required. The decision support system determines the drafting pattern and an animal moving through this AMM and IMM facility can exit in one of five directions. Animals passing through enclosure (A) move directly through to water. Once they have had sufficient water they can exit via a one-way flow system that prevents them re-entering through that gate. The only access to water is via the electronic weighing scales and drafting system. Animals that require no treatment or additional treatment pass directly through to the water and can continue this passage at any time that water is required. In the event of a power failure or error in the drafting system, all gates are set for direct access to the water.

Animals requiring supplementary feeding for the first time are drafted into enclosure (B) where they have access to a feed low in starch and high in fibre and protein in order to cause minimal digestive upset. There is no water available in enclosure (B) and when animals have consumed the feed and require water they can pass out via the spear gates. As with enclosure (A) the exit spear gate is a on-way system preventing the animals from re-entering enclosure (B). Animals can only be drafted through a feeding enclosure as determined by the decision support system. Depending on requirements and the type of feed, access can be on a daily basis or alternatively set at any other interval appropriate given the target weight gain for the animal and its performance as monitored over the electronic scales.

Sheep that have had access to feed in enclosure (B) on three consecutive occasions are drafted on the following day to enclosure (D) where they have access to a feed containing higher levels of grain and less roughage. This feed is only suitable for those that have had access to the introductory diet in enclosure (B). Animals having consumed feed and requiring water pass through the spear gates to water and do not re-enter (D) other than through the drafting system as pre-set by the decision support. As in the case of drafting to enclosure (B), the interval for feeding can be set by the decision support system to be daily, weekly or any other interval.

Sheep losing weight and not responding to supplementary feeding can be diagnosed as requiring treatment for internal parasites. The weight change data is checked against odour detection if available, and the animal drafted through into enclosure (C) where the feed available contains an anthelmintic preparation suitable for treatment of the internal parasite. The amount of feed available is administered via a hopper that delivers a single pre-weighed dose suitable for the weight of animal to be treated. There is no water in enclosure (C) and animals having consumed the medicated feed pass through the spear gate to water. Animals treated in this way are identified in the management system and all records up-dated regarding withholding period prior to sale and the expected difference with respect to live-weight gain with removal of parasites.

Animals detected as losing weight and not responding to supplementary feed can be diagnosed as having external parasites, subject to confirmation of this diagnosis by the odour detection test. These animals are drafted into enclosure (E) and as they pass into enclosure (E) there is a spray or back-line drip applied that has anti-parasite properties able to control the fly-strike. Animals, once treated, pass through to water and do not return via enclosure (E). As for animals passing through enclosure (C) records in the data logger are updated to reflect the fact that chemical has been applied and consequences for chemical withholding periods, organic status of that animal and its expected performance are recorded in the data logger.

An alternative to any of the enclosures described above can be a quarantine holding pen. In the case of a pen designated in this way, animals losing weight, not responding to supplements or anthelmintic treatment are drafted into this pen and are held there until examined by the manager or a veterinarian. The data logger alerts the veterinarian or manager to the fact that animals are held in this pen on a regular basis via SMS messaging or equivalent. Water can be proved in this pen as animals can be held there for several hours pending treatment. The gate out of the pen can be opened automatically by the decision support system on remote instruction from the manager or veterinarian. Alternatively, the gate must be opened manually following treatment of the animals. In the case of manual treatment of animals, any use of chemical is recorded in the data logger.

### Example 8

### Optimising Management Decisions

Within each flock, animals vary with respect to weight, meat characteristics, fleece weight, pregnancy status, fibre characteristics and disease history. At any point in time there is a range of options for the management of the animals in the flock. These include immediate sale, transferred to a paddock with superior pasture, transferred to a paddock with inferior pasture, supplementary feeding, production feeding in a feedlot, parasite management, shearing, sampling for production parameters or disease. The management decision will be influenced by a range of external factors such as current price for livestock and livestock commodities, feed on offer, prospects of pasture growth given current conditions and likelihood of rain, cost of feed, cost of drench, etc. At any time the flock can be segmented so that each segment receives treatment or a management decision that will bring the maximum benefit to the operation in a shorter or longer timeframe. Each decision regarding segmentation and the management of each segment involves a cost and potential benefit. The decision support system is able to optimise the result for the property using short-term costs and benefits as well as longer-term outcomes of importance to breeding and management. This process effectively produces an optimal solution with respect to segmentation and management. Optimal solutions to the management dilemma can be produced at regular intervals in order to respond tactically to changes in price and weather conditions. Animals segmented at one decision point can be combined at another in response to changing market conditions or unexpected seasonal events. Tactical optimisation is achieved through all components of the IAMS and relies on constant monitoring, data integration and decision support as well as the implementation of decisions via auto-drafting combined with nutrition and animal health management.

### Example 9

### Decision Support Software—Virtual Classer Software

### Example 9a

### Virtual Raceside Classer

Many decisions regarding management of livestock or livestock products are made on the basis of information from previous measurements of the animal's performance and characteristics (background data) as well as information collected immediately prior to a sorting (or drafting decision). Presently, the parameter measured at ‘point of decision’ does not typically include information about other animals or products in the cohort and is limited in value because of this deficiency.

Many woolgrowers currently use in-shed or in-yards fibre measuring equipment to assist with allocation of fleeces into sale lots to lower the overall average fibre diameter (FD) of that sale lot, thereby attaining a higher sale price. Fleeces are split into lots based mainly on mean fibre diameter of the individual fleece, usually by either drafting the animals into separate groups at testing time or colour coded tagging for drafting at a later stage. However in most cases additional measurements generated by the testing equipment have been unused because it has not been possible and/or feasible to use the extra measurements at the time of measurement or recall that animal's measurements at a later time (if animal is not tagged).

Accordingly, the ‘Virtual Raceside Classer’ software has been developed to account for cohort variation with respect to the parameter measured or assessed at ‘point of decision’. This represents a real-time decision making aid, based on, as exemplified herein, current measurements of fibre diameter (and variability) that constantly updates these calculations during the measurement process, so as to enable the management of sheep and their fleeces so as to optimise the returns through grouping fleeces in whole consignment lots (wool bales) in combinations that attract the highest price premiums and least discounts. It should also be appreciated that discounts apply to bales incompletely filled and for low numbers of bales of a single specification or category and that ‘Virtual Raceside Classer’ can also be used to ensure that sale lots are complete within target specifications for quantity.

In the present embodiment the software captures measurements of fibre diameter (FD) and coefficient of variation of diameter (CV) directly from the testing machine. The basic process of real time selection involves converting each animal's measurements into a standardized deviation from the mean of all animals for which records are available. The program then calculates the expected index and ranking of the animal in the whole group, (based on the average and variance of the group and a pre-selected breeding index) and determines a destination code according to pre-specified proportions of animals to be classed into various destinations.

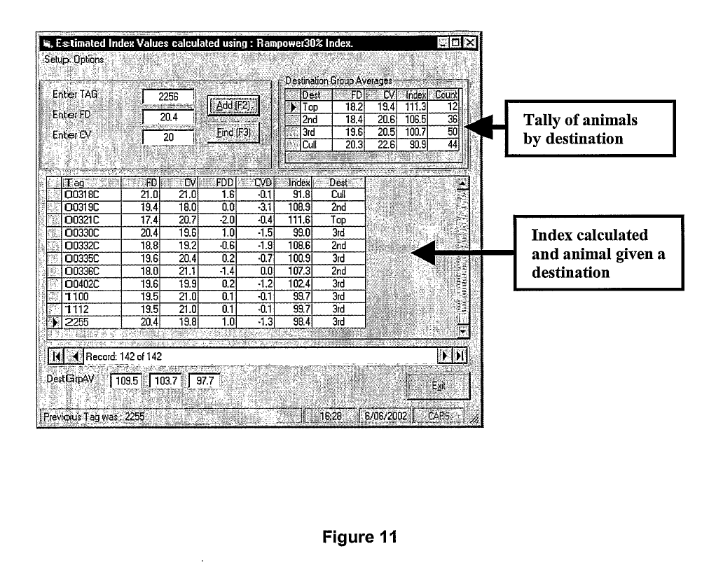

An example of a data entry screen in Virtual Raceside Classer is shown in FIG. 11. As illustrated, the program keeps a tally of the animals classed into each destination group and the average measurements of these groups. Specifying an approximate likely mean FD and mean CV at start-up aids in the classification of animals in the first measured group (or race). As measurements from more animals are added, the average and variance of the group is constantly updated. Some errors in destination are possible in the first few animals, because of the lack of numbers, but this has very little impact on the overall result. If required, a breeder could put aside the first race fall of animals and re-test them at the end of the group to reallocate their destinations.

A combination of this approach with presently available software such as ‘Virtual Woolclasser’ (see Example 9b below) immediately prior to shearing could be employed to identify a shearing order (for clip preparation) and a selection destination in a single run through the flock, without the need for a permanent identification in the animals.

The process of real time selection can be extended to more complex selection processes. A number of traits measured at different times might contribute to a final selection decision, but it is not necessary to wait until all the data is collected and processed before selection can proceed. The required information can be built using both the principles of index selection and real-time selection in an interactive way.

For example, fibre diameter and CV of diameter may be collected prior to shearing. At shearing, fleece weights may be recorded and then, after shearing, a body weight is added at which point final selection decisions are required. At each stage, pre-, at and post-shearing, the data is added and an interim index is calculated. At the final weighing, the body weight is added and the final selection index calculated in real time so that the animal can be allocated (and drafted) according to its final index. Apart from the final index being calculated in real time, some preliminary selection is possible on the basis of earlier information alone. For example, only a selected proportion of animals might be fleece weighed or body weighed depending on their ranking on a preliminary index involving fibre diameter and CV of diameter. Even without a final measurement phase, having the information available on screen at the time of allocating a destination would still be more useful than having the information in printed list form only.

The ‘Virtual Raceside Classer’ software finds various additional applications to those exemplified above. For example, in the same way as described above for grouping fleeces into complete sale lots, the ‘Virtual Raceside Classer’ can be used to optimise assembly of sale lots of carcases within an abattoir to fill orders of predetermined specifications with respect to quality and volume. In this case decision making is typically based on information available from the live animal (eg. genetics, application of any chemical or animal health remedy, age, growth rate etc) as well as information measured at ‘point of decision’ such as carcase weight and fat cover.

Further, the ‘Virtual Raceside Classer’ software can also be used, for example, in selection and management of live animals where historic information such as breeding and pedigree information, animal health history, wool production, reproductive performance can be combined with a ‘point of decision’ measurement such as liveweight measurement, pregnancy status (e.g. 0, single or twins) to draft animals into sale, mating or supplementary feeding groups.

Additionally, the ‘Virtual Raceside Classer’ software can be used, for example, in management and marketing decisions for a wide range of livestock products such as skins and various forms of offal where ‘point of decision’ measurement can profitably be combined with prediction of cohort values and previous records.

### Example 9b

### Virtual WoolClasser

Some measurements on livestock can be used to make an instant decision that can extract value from grouping animals, or their products, to optimise returns. An example of such a measurement is fibre diameter of wool that is the major determinant of price received. By segmenting a flock into component fleeces according to fibre diameter, a range in sale lines can be obtained that, when sold separately, will give greater returns that from having a single heterogeneous sale line where the price will be determined by the average fibre diameter across all fleeces.

The Virtual WoolClasser is a computer algorithm developed by to allow wool growers to achieve maximum financial benefit from objective classing of their wool clip on measured fibre diameter.

The software is suitable for use with both pre-shearing measurements and in-shed testing. The program uses a routine that allocates fleeces to binlines based on their fibre diameter, while allowing potential prices for bale lines to be optimised. It allows the user to determine the appropriate number of fleece wool lines and the cut-off limits for the fibre diameter of individual fleeces to make up the lines. The optimisation works to maximise the price received while minimising the extra costs of selling smaller lots. A number of inputs to specify flock numbers and production details (greasy fleece weight, fibre diameter, yield and skirting ratio) are used to predict the total wool production of the flock.

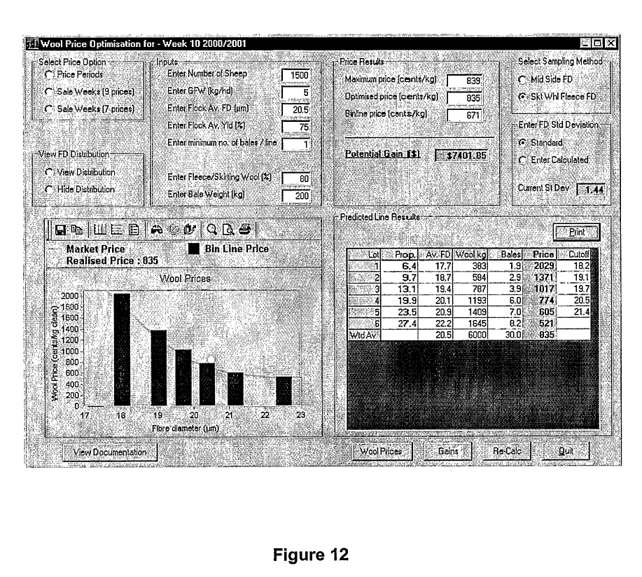

The clip is subdivided into separate 1-bale lines each with an estimated diameter. The correlation between fleece weight and fibre diameter, whereby heavy fleeces also tend to be broader in diameter, is accounted for in this subdivision. For a specified set of market values, the expected prices of each bale and the whole clip (as a single sale lot) can be found by either a complex polynomial relationship between diameter and price or linear interpolation between (half-) micron categories. Using the costs of selling lots of varying sizes, the optimum number of sale lots that maximise price after selling costs is found iteratively and the cut-offs on measured diameter to form these lots are determined (as illustrated in the exemplary screenshot in FIG. 12).

Additional screens allow the user to update the market information for micron categories, view the fibre diameter distribution for the flock and assess the economic impact of the objective classing operation. In addition, likely diameter and price specifications for lots give information useful in marketing the clip. A printed extract of the results is produced. Documentation for help and answers to frequently asked questions are available in the software and a user's manual.

An additional application of the Virtual WoolClasser software is to form slaughter groups of meat animals based on live weight (and/or possibly fat score). In this embodiment, the sale lines would be a slaughter unit or “truck-load” and the optimisation would be based on the immediate value of a group of animals compared with their future value, discounted for costs, of retaining them on farm. The program can also be modified for optimising sale and management of other livestock where there are finite group sizes and premium prices paid for animals and products meeting different specifications.

### Example 10

### Compliance of IAMS to EPC

As disclosed herein, compliance of an integrated animal management system of the invention with Electronic Product Code (EPC) standards may be achieved. One example of such compliance follows in relation to the transfer of animals from the primary producer to the wholesailer/retailer of animal products, via a saleyard and abattoir.

1. Sheep producer (‘Manufacturer’)

Each participating producer sets up a defined object name service (ONS) directory registered with the VeriSign company or equivalent management agency and establishes a standard EPC-IS (information storage system compliant with EPC standards). This EPC-IS at the farm level contains the history and production data for each animal. The farm EPC-IS can be based on a modified livestock management data-base program.

2. Saleyard

Each saleyard requires its own EPC-IS where information is recorded on animals moving in and out of the system together with sale date, price and information such as destination. Agricultural agents such as Elders or Landmark could assist in managing information for a number of producers and saleyards to facilitate uniform standards and benefits of scale.

3. Abattoir

Each abattoir requires its own local ONS directory as well as an EPC-IS. Means are included for reconciliation of the original EPC details for each animal received (original animal specification), with new a EPC describing characteristics of carcase or packaged meat leaving the abattoir.

4. Wholesaler/Retailer/Restaurant

Subsequent movement of the product from abattoir to the wholesaler or retailer for example would accord with current EPC standards and established protocols.

Product authenticity—‘organic’ or ‘chemical free’ status

As disclosed herein, an embodiment of an integrated animal management system according to the invention provides records of all management actions including date and details of all chemical treatment of animals to control external or internal parasites, all introduced feed and the origin of those feeds as well as the performance and wellbeing of each animal throughout its life. These data, available to buyers and data auditors, provide a record of authenticity required for specific markets where consumers demand ‘organic’ food, ‘chemical free’ produce or prescribed standards of animal welfare. The connectivity described above links records of individual animals and their management in the farm EPC-IS in a form that can be accessed by all segments of the supply chain through to consumers. Through the EPC network or through schemes such as the National Livestock Identification Scheme (NLIS) in Australia there is a ‘track and trace’ capability to follow each animal when it moves from one property to another or is sold for meat production. In this way the IAMS framework also provides the basis for quality assurance, product authenticity and ‘track and trace’ capabilities that add value to livestock products.

1. A system for the intensive management of animals, the system comprising:
(a) animal identification means for identifying individual animals;
(b) at least one device for measuring one or more parameters of individual animals;
(c) a processor for processing measurements obtained for the one or more parameters, wherein the processed parameter data is used to determine management strategies for individual animals in real-time; and
(d) means for implementing management strategies for the animals.

2. The system according to claim 1, wherein the animals are grazing animals.

3. The system according to claim 2, wherein the grazing animals are selected from:
sheep, cattle, goats and horses.

4. The system according to claim 3 wherein the animals are sheep.

5. The system according to any one of the preceding claims, wherein the one or more parameters include weight, temperature, odour, gas, colour and visual characteristics.

6. The system according to any one of the preceding claims wherein the system further comprises:
(e) a database for storing processed real-time parameter data.

7. The system according to claim 6, wherein historical data for individual animals is stored in the database.

8. The system according to claim 7, wherein the historical data includes one or more of the following: genetic data; pedigree information; phenotypic characteristics;
and previous parameter data processed by the processor.

9. The system according to claim 7 or 8, wherein the processor correlates real-time processed parameter data with historical data stored in the database to determine the management strategy for an individual animal.

10. The system according to any one of the preceding claims wherein the processor correlates real-time processed data with external information to determine the management strategy for an individual animal.

11. The system according to claim 10 wherein the external information includes one or more of market information, transactional information, and industry benchmarks for animal health and performance.

12. The system according to claim 11 wherein market and transactional information includes animal and animal product prices, commodity costs and production monitoring costs.

13. The system according to claim 7 wherein processed parameter data and/or historical data for an individual animal is compared with corresponding processed parameter data and/or historical data for one or more other animals in the same group to determine the management strategy.

14. The system according to any one of the preceding claims wherein the management strategy determined is implemented for more than one animal within the same group.

15. The system according to any one of the preceding claims wherein the animal identification means comprises a tracking device, the tracking device comprises a transponder attached to the animal and a receiver.

16. The system according to claim 15 wherein the receiver is located in a race, gate or adjacent a feed or water trough.

17. The system according to claim 15 wherein the receiver of the animal identification means and the at least one device for measuring one or more parameters are located in a race, gate or adjacent a feed or water trough.

18. The system according to claim 17 wherein the gate is a spear gate, boom lever, animal-activated gate, electronically activated gate or other suitable gating mechanism.

19. The system according to any one of the preceding claims wherein the at least one device for measuring one or more parameters is selected from the group consisting of: a weighing device; a load sensor, a temperature detector; an odour detector; a gas detector and an image analysis device.

20. The system according to claim 19, wherein the processor includes an algorithm to calibrate parameters of weight, temperature, odour, gas emissions, colour or other characteristics of an individual animal with disease, nutrition and performance states to diagnose the state of health and performance of the animal and determine the management strategy for the animal.

21. The system according to claim 19 wherein the weighing device comprises a platform suspended between two or more load cells and the processor includes an algorithm to calibrate weight and/or weight change in an animal with nutritional state, disease conditions, parasitic infections and nutritional value of pasture and feed.

22. The system according to claim 21 wherein the parasitic infections are infections caused by external or internal parasites.

23. The system according to claim 22 wherein the external parasites are selected from blowflies (Lucilia cuprina) and lice (Bovicola ovis).

24. The system according to claim 22 wherein the internal parasites are selected from Trichostrongylus colubriformis, Trichostrongylus vitrinus, Ostertagia circumcincta, Haemonchus contortus and Nematodirus spp.

25. The system according to claim 19 wherein the load sensor senses the speed and weight placement of an animal's feet on the sensor thereby indicating temperament and/or physical impairment of the animal.

26. The system according to claim 19 wherein the temperature detector is an infra-red thermal scanner for detecting the body temperature of an animal and wherein the processor includes an algorithm to calibrate temperature and temperature changes in the animal with disease conditions, parasitic infections or heat stress.

27. The system according to claim 19, wherein the odour detector is an electronic sensor to detect the odour emitted from one or more locations on an animal and the processor includes an algorithm to calibrate the odour emitted with conditions including flystrike, footrot, fleece rot, dags, diarrhoea, acidosis and internal or external parasitic infections.

28. The system according to claim 27 wherein the odour detector further comprises air sampling means for sampling air surrounding specific regions of an animal's body, the sampled air being used in the diagnosis of conditions including flystrike, footrot, fleece rot, dags, diarrhoea, acidosis and internal or external parasitic infections.

29. The system according to claim 19, wherein the gas detector samples gas emitted from the mouth, nose and/or anus of the animal to detect metabolites, and wherein the processor includes an algorithm to calibrate metabolite levels with weight loss, fermentative ability of the animal and nutritional requirements of the animal.

30. The system according to claim 29 wherein the metabolites include methane and ketone bodies.

31. The system according to claim 19, wherein the odour detector is a dog.

32. The system according to claim 19, wherein the image analysis device is a scanning device or digital camera to detect pigment and colour of an animal's skin, and wherein the processor includes an algorithm to calibrate colour and pigmentation with red blood cell levels, metabolic disorders, disease conditions or parasitic infections.

33. The system according to claim 19, wherein the processor includes an algorithm to calibrate colour and pigmentation with the presence of faecal stains, urine stains, flystrike, pizzle rot or damage to wool or skin.

34. The system according to claim 32 wherein the metabolic disorder is haemonchosis resulting in anaemia.

35. The system according to any one of claims 19 to 34, wherein visual and physical assessment information on the animal is recorded via voice-recognition software or category scores identified by remote control, radio frequency identification or barcode classifications.

36. The system according to any one of claims 19 to 35, wherein the processor correlates data for any two or more measured parameters to determine the management strategy for an individual animal or group of animals.

37. The system according to any one of the preceding claims wherein the management strategy comprises determining and/or implementing an effective treatment for the animal, including feed requirements, chemical treatment requirements, quarantine requirements, other welfare requirements of the animal, or the grouping of animals for sale or genetic selection.

38. The system according to claim 37, wherein feed requirements include formulations of protein and/or amino acids or other feed supplements, medicated and feed and water intake levels.

39. The system according to claim 37 wherein chemical treatment requirements include antibiotics, anti-fungal agents and antiparasitic agents active against internal or external parasites.

40. The system according to any one of the preceding claims wherein the means for implementing management strategies comprises means to draft one or more animals into a predetermined location thereby enabling the appropriate treatment as defined in any one of claims 37 to 39 to be administered to the one or more animals.

41. The system according to claim 34 wherein the means for implementing management strategies further comprises automatic means for administering the required treatment as defined in any one of claims 37 to 39.

42. The system according to any one of the previous claims wherein the processor is remote from the animal identification means and at least one device for measuring one or more parameters, and wherein the system further comprises:
(f) a transmitter for transmitting measured parameter data from the at least one device to the processor.

43. The system according to claim 42, wherein the data is transmitted via digital wireless network or satellite modem for remote Internet-based access.

44. A method for the intensive management of animals, the method comprising the steps of:
(a) identifying individual animals;
(b) measuring one or more parameters of identified individual animals;
(c) transmitting the measured real-time parameter data to a central processor;
(d) processing the transmitted data; and
(e) determining and/or implementing management strategies for individual animals on the basis of the processed data.

45. The method according to claim 44, wherein the animals are grazing animals.

46. The method according to claim 45, wherein the grazing animals are selected from:
sheep, cattle,goats and horses.

47. The method according to claim 46 wherein the animals are sheep.

48. The method according to any one of claims 44 to 47, wherein the one or more parameters include weight, temperature, odour, gas, colour and visual characteristics.

49. The method according to any one of claims 44 to 48 wherein the method further comprises:
(f) storing transmitted real-time parameter data on a database.

50. The method according to claim 49, wherein historical data for individual animals is stored in the database.

51. The method according to claim 50, wherein the historical data includes one or more of the following: genetic data; pedigree information; phenotypic characteristics; and previous processed parameter data.

52. The method according to claim 50 or 51, wherein transmitted real-time parameter data is correlated with historical data stored in the database to determine the management strategy for an individual animal.

53. The method according to any one of claims 44 to 52 wherein the transmitted real-time data is correlated with external information to determine the management strategy for an individual animal.

54. The method according to claim 53 wherein the external information includes one or more of market information, transactional information, and industry benchmarks for animal health and performance.

55. The method according to claim 54 wherein market and transactional information includes animal and animal product prices, commodity costs and production monitoring costs.

56. The method according to claim 50 wherein the measured real-time parameter data and/or historical data for an individual animal is compared with corresponding real-time parameter data and/or historical data for one or more other animals in the same group to determine the management strategy.

57. The method according to any one of claims 44 to 56 wherein the management strategy determined is implemented for more than one animal within the same group.

58. The method according to any one of claims 44 to 55 wherein animals are identified via a tracking device, the tracking device comprising a transponder attached to the animal and a receiver.

59. The method according to claim 58 wherein the receiver is located in a race, gate or adjacent a feed or water trough.

60. The method according to claim 59 wherein the receiver is located in a race, gate or adjacent a feed or water trough together with means for measuring the one or more parameters of identified animals.

61. The method according to claim 60 wherein the gate is a spear gate, boom lever, animal-activated gate, electronically activated gate or other suitable gating mechanism.

62. The method according to claim 60 wherein the means for measuring one or more parameters is selected from one or more of the group consisting of: a weighing device; a load sensor, a temperature detector; an odour detector; a gas detector and an image analysis device.

63. The method according to claim 62, wherein parameters of weight, temperature, odour, gas emissions, colour or other characteristics of an individual animal are correlated with condition states to diagnose the state of health of the animal and determine the appropriate management strategy for the animal.

64. The method according to claim 62 wherein the weighing device comprises a platform suspended between two or more load cells and weight and weight change in the animal is correlated with nutritional state, disease conditions, parasitic infections in the animal and nutritional value of pasture and feed.

65. The method according to claim 62 wherein the load sensor senses the speed and weight placement of an animal's feet on the sensor thereby indicating temperament and/or physical impairment of the animal.

66. The method according to claim 62 wherein the temperature detector is an infra-red thermal scanner for detecting the body temperature of the animal and temperature and temperature changes in the animal are correlated with disease conditions, parasitic infections in the animal or heat stress.

67. The method according to claim 62, wherein the odour detector is an electronic sensor to detect the odour emitted from one or more locations on the animal and the odour emitted is correlated with conditions including fly strike, footrot, fleece rot, dags, diarrhoea, acidosis and internal or external parasitic infections in the animal.

68. The method according to claim 62, wherein the gas detector samples gas emitted from the mouth, nose and/or anus of the animal to detect metabolites including ketone and methane, and wherein metabolite levels are correlated with weight loss, fermentative ability of the animal and nutritional requirements of the animal.

69. The method according to claim 62, wherein the image analysis device is a scanning device or digital camera to detect pigment and colour of the animal's skin, and wherein colour and pigmentation are correlated with red blood cell levels, parasitic infections and metabolic disorders such as haemonchosis resulting in anaemia.

70. The method according to any one of claims 62 to 69, wherein visual or physical assessment information on the animal is recorded via voice-recognition software or category scores identified by remote control, radio frequency identification or barcode classifications.

71. The method according to any one of claims 62 to 70, wherein the data obtained for any two or more measured parameters is correlated to determine the management strategy for an animal or group of animals.

72. The method according to any one of claims 44 to 71 wherein the management strategy comprises determining an effective treatment for the animal, including feed requirements, chemical treatment requirements, quarantine requirements, other welfare requirements of the animal or the grouping of animals for sale or genetic selection.

73. The method according to claim 72, wherein feed requirements include formulations of protein and/or amino acids or other feed supplements, medicated and feed and water intake levels.

74. The method according to claim 72 wherein chemical treatment requirements include antibiotics, anti-fungal agents and antiparasitic agents active against internal or external parasites.

75. The method according to any one of claims 44 to 74, wherein the data is transmitted via digital wireless network or satellite modem for remote Internet-based access.

76. A system for the intensive management of sheep, the system comprising:
(a) identification means for identifying individual sheep;
(b) at least one device for measuring one or more parameters of individual sheep;
(c) a processor for processing measurements obtained for the one or more parameters, wherein the processed parameter data is used to determine management strategies for individual sheep in real-time; and
(d) at least one device for implementing management strategies for the sheep.

77. A method for the intensive management of sheep, the system comprising:
(a) identifying individual sheep;
(b) measuring one or more parameters of identified individual sheep;
(c) transmitting the measured parameter data to a central processor;
(d) processing the transmitted data; and
(e) determining and/or implementing management strategies for individual sheep on the basis of the processed data in real-time.
